(19) United States
(12) Patent Application Publication
(10) Pub. No.: US 2021/0331686 A1
(43) Pub. Date: Oct. 28, 2021

(54) Systems and Methods for Handling Autonomous Vehicle Faults

(71) Applicant: UATC, LLC, San Francisco, CA (US)

(72) Inventors: Nathan Thomas Beyers, Pittsburgh, PA (US); Christopher John Peplin, Wilkinsburgh, PA (US); Steve Payne, Pittsburgh, PA (US); Daniel Joseph Tascione, Monroeville, PA (US); Jordan Peter Brindza, Pittsburgh, PA (US); Dillon Collins, Pittsburgh, PA (US); Julie Marie Derence, Pittsburgh, PA (US); Eric Michael Perko, Pittsburgh, PA (US); Aaron Botwick, Pittsburgh, PA (US)

(21) Appl. No.: 16/915,310

(22) Filed: Jun. 29, 2020

Related U.S. Application Data
(60) Provisional application No. 63/013,842, filed on Apr. 22, 2020.

(51) Int. Cl. B60W 50/02; B60W 60/00; B60W 30/06

(52) U.S. Cl. CPC B60W 50/0205; B60W 30/06; B60W 60/0053; B60W 60/0015

(57) ABSTRACT

Systems and methods for handling autonomous vehicle faults are provided. A system includes a plurality of function nodes arranged in a directed graph architecture. The function nodes include a plurality of detector nodes and a plurality of fault handler nodes. Each detector node is communicatively connected to at least one function node and an associated fault handler node. The detector node is configured to obtain output from the function node, detect a fault, and provide a fault event to the associated fault handler node. Each fault handler node can be associated with a fault severity and a corresponding vehicle action. The associated fault handler node can receive the fault event from the detector node and initiate a fault response. The fault response can include initiating a respective vehicle action in response to the fault.

### RELATED APPLICATION

The present application is based on and claims benefit of U.S. Provisional Patent Application No. 63/013,842 having a filing date of Apr. 22, 2020, which is incorporated by reference herein.

### FIELD

The present disclosure relates generally to fault management systems. In particular, a directed graph architecture can be utilized to identify and process faults within a vehicle computing system.

### BACKGROUND

An autonomous vehicle can be capable of sensing its environment and navigating with little to no human input. In particular, an autonomous vehicle can interact with devices that run a plurality of processes. Each process can include a series of functions configured to communicate function data via directed edges. The data can include fault information. A fault management system can monitor the fault information and initiate vehicle actions in response to certain faults.

### SUMMARY

Aspects and advantages of embodiments of the present disclosure will be set forth in part in the following description, or may be learned from the description, or may be learned through practice of the embodiments.

One example aspect of the present disclosure is directed to a vehicle fault management system of a vehicle computing system including one or more computing devices. The one or more computing devices can include a plurality of function nodes arranged in a directed graph architecture. The plurality of function nodes can include a plurality of detector nodes and a plurality of fault handler nodes. Each respective detector node is defined by a fault type and associated with a fault handler node. The one or more computing device can include one or more processors and one or more memories storing a set of computer readable instructions that when executed by the one or more processors cause the processors to perform operations. The operations include obtaining, by a detector node, function data from one or more function nodes of the plurality of function nodes. The operations include detecting, by the detector node, an existence of a fault associated with an autonomous vehicle based, at least in part, on the function data. The operations include outputting, by the detector node to an associated fault handler node, a fault event indicative of the existence of the fault and the fault type of the respective detector node. And, the operations include initiating, by the associated fault handler node, a fault response for the autonomous vehicle based, at least in part, on the fault event.

Yet another example aspect of the present disclosure is directed to an autonomous vehicle including a vehicle computing system. The vehicle computing system includes one or more computing devices, the one or more computing devices include a plurality of function nodes arranged in a graph architecture. The plurality of function nodes include a plurality of detector nodes, each respective detector node is associated with a fault type, and a plurality of fault handler nodes. Each respective detector node is associated with a fault handler node. The autonomous vehicle includes one or more processors and one or more memories storing a set of computer readable instructions that when executed by the one or more processors cause the processors to perform operations. The operations include obtaining, by a first detector node, first function data from one or more first function nodes of the plurality of function nodes. The operations include detecting, by the first detector node, an existence of a first fault based, at least in part, on the first function data. The operations include outputting, by the first detector node to a first fault handler node, a first fault event indicative of the existence of the first fault and the first fault type of the first detector node. And, the operations include initiating, by the first fault handler node, a fault response based, at least in part, on the first fault event.

Yet another example aspect of the present disclosure is directed to a computer-implemented method for handling faults of a vehicle. The vehicle includes a vehicle computing system that is onboard the vehicle. The vehicle computing system includes a directed graph architecture including a plurality of nodes. The method includes receiving, by a first type of node of the vehicle computing system, function data from at least one function node of the computing system. The method includes detecting, by the first type of node of the vehicle computing system, an existence of a fault based, at least in part, on the function data. The method includes outputting, by the first type of node to a second type of node of the vehicle computing system, a fault event indicative of the existence of the fault and a fault type of the fault. And, the method includes initiating, by the second type of node of the vehicle computing system, at least one fault response based, at least in part, on the fault event and a context of the vehicle computing system. The context of the vehicle computing system is indicative of a state of the vehicle computing system.

Other example aspects of the present disclosure are directed to other systems, methods, vehicles, apparatuses, tangible non-transitory computer-readable media, and devices for handling faults in a computing system. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram of an example system according to example embodiments of the present disclosure;

FIG. 2A depicts a diagram of an example system including a plurality of devices configured to execute one or more processes according to example implementations of the present disclosure;

FIG. 2B depicts a diagram of an example functional graph according to example implementations of the present disclosure;

FIG. 3 depicts an example fault management system according to example implementations of the present disclosure;

FIG. 4 depicts an example fault detector data flow diagram according to example implementations of the present disclosure;

FIG. 5 depicts an example fault detector combination according to example implementations of the present disclosure;

FIG. 6 depicts an example fault handler data flow diagram according to example implementations of the present disclosure;

FIG. 7 depicts an example fault propagation technique according to example implementations of the present disclosure;

FIG. 8 depicts a flowchart of a method of managing faults according to aspects of the present disclosure;

FIG. 9 depicts example system with various means for performing operations and functions according example implementations of the present disclosure; and

FIG. 10 depicts a block diagram of an example computing system according to example embodiments of the present disclosure.

### DETAILED DESCRIPTION

Aspects of the present disclosure are directed to improved systems and methods for handling faults such as, for example, handling faults of an autonomous vehicle. For instance, a computing system of an autonomous vehicle can include a plurality of devices (e.g., physically-connected devices, wirelessly-connected devices, virtual devices running on a physical machine, etc.). The computing devices can be included in the vehicle's onboard computing system. For instance, the computing devices can implement the vehicle's autonomy software that allow the vehicle to autonomously operate within its environment. Each device can be configured to run one or more processes. A process can include a plurality of function nodes (e.g., software functions) connected by one or more directed edges that dictate the flow of data between the plurality of function nodes. A device can execute (e.g., via one or more processors, etc.) a respective plurality of processes to run a respective function node. The plurality of processes can be collectively configured to perform one or more tasks or services of the computing system. To do so, the plurality of processes can be configured to communicate (e.g., send/receive messages) with each other over one or more communication channels (e.g., wired and/or wireless networks). By way of example, with respect to the vehicle's onboard computing system, its processes (and their respective function nodes) can be organized into a directed software graph architecture (e.g., including sub-graphs) that can be executed to communicate and perform the operations of the autonomous vehicle (e.g., for autonomously sensing the vehicle's environment, planning the vehicle's motion, etc.). The technology of the present disclosure provides improved system configurations and methods for detecting autonomous vehicle faults by leveraging, for example, such a graph architecture.

For instance, a computing system can utilize a fault management system to detect and handle the existence of faults within an onboard computing system of an autonomous vehicle. The fault management system, for example, can include a number of detector nodes and fault handler nodes placed throughout the directed graph architecture. Each detector node can be communicatively connected to a function node and a fault handler node. The detector node can obtain function data from the function node, detect an existence of a fault based on the function data, and output a fault event indicative of the fault to the fault handler node. The fault handler node can receive the fault event and, in response, initiate a fault response for the autonomous vehicle based on the fault event. The computing system can include a single fault handler node for each of a plurality of defined fault severity levels associated with the autonomous vehicle. Each fault severity level can correspond to a level of severity and a vehicle action (e.g., an emergency stopping maneuver, a parking maneuver, a navigation to a maintenance facility, etc.) for responding to a fault of the corresponding level of severity. For example, as further described herein, a fault handler can be placed in line within the directed graph architecture to control the flow of data to a function node configured to implement a vehicle action for responding to a fault of a respective severity level.

The fault management system reduces the response time to a fault by mapping each fault detector of a certain type directly to a fault handler (e.g., via one or more directed edges of the directed graph architecture) configured to handle faults of that type. Moreover, by including a designated fault handler for each fault severity level, the system simplifies fault detection in otherwise robust computing systems (e.g., such as autonomy systems in autonomous vehicles). This, in turn, enables the system to implement flexible responses to the existence of a variety of potential faults of differing seventies. Moreover, by placing a fault handler in line with the directed graph architecture, a fault handler for faults of a respective fault severity level can initiate a vehicle action, block faulty data from reaching the function node responsible for the vehicle action, or permit the normal flow of data traffic to the function node based on the existence of a fault. Ultimately, this enhances the safety of self-driving systems by increasing the speed, efficiency, and flexibility in which a vehicle can handle internal and/or external faults.

The following describes the technology of this disclosure within the context of an autonomous vehicle for example purposes only. As described herein, the technology described is not limited to autonomous vehicles and can be implemented within other robotic and computing systems, such as those managing faults from a plurality of computing functions.

An autonomous vehicle (e.g., ground-based vehicle, aerial-vehicle, bike, scooter, other light electric vehicles, etc.) can include various systems and devices configured to control the operation of the vehicle. For example, an autonomous vehicle can include an onboard vehicle computing system (e.g., located on or within the autonomous vehicle) that is configured to operate the autonomous vehicle. Generally, the vehicle computing system can obtain sensor data from a sensor system onboard the vehicle, attempt to comprehend the vehicle's surrounding environment by performing various processing techniques on the sensor data, and generate an appropriate motion plan through the vehicle's surrounding environment.

More particularly, the autonomous vehicle can include a vehicle computing system with a variety of components for operating with minimal and/or no interaction from a human operator. The vehicle computing system can be located onboard the autonomous vehicle and include one or more sensors (e.g., cameras, Light Detection and Ranging (LIDAR), Radio Detection and Ranging (RADAR), etc.), a positioning system (e.g., for determining a current position of the autonomous vehicle within a surrounding environment of the autonomous vehicle), an autonomy computing system (e.g., for determining autonomous navigation), a communication system (e.g., for communicating with the one or more remote computing systems), one or more vehicle control systems (e.g., for controlling braking, steering, powertrain), a human-machine interface, etc.

The autonomy computing system can include a number of sub-systems that cooperate to perceive the surrounding environment of the autonomous vehicle and determine a motion plan for controlling the motion of the autonomous vehicle. For example, the autonomy computing system can include a perception system configured to perceive one or more objects within the surrounding environment of the autonomous vehicle, a prediction system configured to predict a motion of the object(s) within the surrounding environment of the autonomous vehicle, and a motion planning system configured to plan the motion of the autonomous vehicle with respect to the object(s) within the surrounding environment of the autonomous vehicle. One or more of these sub-systems can be combined and/or share computational resources.

The autonomy computing system (e.g., one or more subsystems of the autonomous computing system) can include a plurality of devices configured to communicate over one or more wired and/or wireless communication channels (e.g., wired and/or wireless networks). Each device can be associated with a type, an operating system, and/or one or more designated tasks. A type, for example, can include an indication of the one or more designated tasks of a respective device. The one or more designated tasks, for example, can include performing one or more processes and/or services of the computing system.

Each device of the plurality devices can include and/or have access to one or more processors and/or one or more memories (e.g., RAM memory, ROM memory, cache memory, flash memory, etc.). The one or more memories can include one or more tangible non-transitory computer readable instructions that, when executed by the one or more processors, cause the device to perform one or more operations. The operations can include, for example, executing one or more of a plurality of processes of the vehicle computing system. For instance, one or more of the devices can include a compute node configured to run one or more processes of the plurality of processes of the vehicle computing system. In some implementations, a process (e.g., of the vehicle computing system) can include a plurality of function nodes (e.g., pure functions) connected by one or more directed edges that dictate the flow of data between the plurality of function nodes. The plurality of function nodes can include a plurality of subroutines configured to carry out one or more tasks for the respective process of the vehicle computing system. Each of the one or more devices can execute (e.g., via one or more processors, etc.) the respective plurality of function nodes to run the respective process.

For example, the plurality of function nodes can be arranged in one or more function graphs. A function graph can include a series of function nodes arranged (e.g., by one or more directed edges) in a pipeline, directed graph, etc. The function nodes can include a computing function with one or more inputs (e.g., of one or more data types) and one or more outputs (e.g., of one or more data types). For example, the function nodes can be implemented such that they define one or more accepted inputs (e.g., function input data) and one or more outputs (e.g., function output data). In some implementations, each function node can be configured to obtain one or more inputs of a single data type, perform a single function, and output one or more outputs of a single data type.

The function nodes can be connected by one or more directed edges of a function graph, a subgraph of the function graph, etc. For example, the one or more directed edges can facilitate communication over a first channel (e.g., a first frequency channel). In this manner, the plurality of function nodes can be communicatively connected, via the one or more directed edges, over a first channel. The one or more directed edges can dictate how data flows through the function graph, subgraph, etc. For example, the one or more directed edges can be formed based on the defined inputs and outputs of each of the function nodes of the function graph. Each function graph can include an injector node and an ejector node configured to communicate with one or more remote devices and/or processes outside the function graph. The injector node, for example, can be configured to communicate with one or more devices (e.g., sensor devices, etc.) and/or processes outside the function graph to obtain input data for the function graph. The ejector node can be configured to communicate with one or more devices and/or processes outside the function graph to provide output data of the function graph to the one or more devices and/or processes.

The one or more computing devices of the vehicle computing system can be configured to execute one or more function graphs to run one or more processes of the plurality of processes. Each process can include an executed instance of a function graph and/or a subgraph of a function graph. For example, in some implementations, a function graph can be separated across multiple processes, each process including a subgraph of the function graph. In such a case, each process of the function graph can be communicatively connected by one or more function nodes of the function graph. In this manner, each respective device can be configured to run a respective process by executing a respective function graph and/or a subgraph of the respective function graph.

Thus, each function graph can be implemented as a single process or multiple processes. In some implementations, one or more of the plurality of processes can include containerized services (application containers, etc.). For instance, each process can be implemented as a container (e.g., docker containers, etc.). For example, the plurality of processes can include one or more containerized processes abstracted away from an operating system associated with each respective device.

As described herein, each function node of the plurality of function nodes arranged in a directed graph architecture (e.g., including a plurality of function graphs) can be configured to obtain function input data associated with an autonomous vehicle based on the one or more directed edges (e.g., of the directed graph). The function nodes can generate function output data based on the function input data. For instance, the function nodes can perform one or more functions of the autonomous vehicle on the function input data to obtain the function output data. The function nodes can communicate the function output data to one or more other function nodes of the plurality of function nodes based on the one or more directed edges of the directed graph.

At times, the function output data can be indicative of the existence of one or more faults associated with the autonomous vehicle. By way of example, a function node can include a compressor status parser function node configured to receive input function data from an air compressor sensor. The compressor status parser function node can perform a parser function on the input function data to determine an air pressure for an air tank of the autonomous vehicle. The compressor status parser function node can output function output data indicative of the air pressure of the air tank to one or more function nodes of the directed function graph. The output function data can be indicative of the existence of one or more faults in the event the air pressure is abnormal.

For example, a fault can be indicative of an off-nominal condition that can lead to a system or part of a system failure. A system failure can include an unacceptable performance of system software (e.g., a function node of the directed graph, etc.), system hardware (e.g., a sensor, air compressor, etc.), and/or any other portion of the system. The existence of a fault can be indicative of an active state of a respective off-nominal condition. By way of example, a fault can indicate a hardware failure such as low air pressure in an air compressing system, etc. and/or a software failure such as the blocking of an execution of a process, a deadlock, a livelock, an incorrect allocation of execution time, an incorrect synchronization between software elements (e.g., function nodes of the directed graph), a corruption of message content, an unauthorized read/write access to memory allocated to another software element, a repetition of information, a loss of information, a delay of information, an unauthorized insertion of information, a masquerade or incorrect addressing of information, an incorrect sequence of information, and/or an otherwise corruption of information, etc.

The present disclosure is directed to a vehicle fault management system integrated within an autonomous vehicle (e.g., an autonomy system of the autonomous vehicle). The vehicle fault management system can include the plurality of function nodes arranged in a directed graph architecture, as described herein. For instance, the directed graph architecture can define a directed graph including a plurality of function nodes arranged in one or more function graphs, each function node of the one or more function graphs can be connected by a directed edge as prescribed by the directed graph architecture. The function nodes can perform functions that are associated with the operation of the autonomous vehicle (e.g., processing sensor data, determining object trajectories, analyzing hardware performance, etc.). The plurality of function nodes can include a plurality of detector nodes and a plurality of fault handler nodes. Each detector node can be defined by a fault type and can be associated with a respective fault handler node (e.g., based on the fault type).

More particularly, the plurality of function nodes can include a plurality of detector nodes placed throughout the directed graph. A detector node can be configured to obtain function data (e.g., function output data) from one of more function nodes of the plurality of function nodes of the directed graph. For example, the detector node can include a computing function (e.g., a pure function) subscribed to the data outputs of one or more function nodes. The detector node can be configured to monitor the function output provided by each of the one or more function nodes. For example, a detector node can be configured to detect a LIDAR sensor temperature fault (e.g., the LIDAR operating outside its specified temperature range) based on data from LIDAR system temperature data provided via one or more function nodes associated with the LIDAR system.

In some implementations, the detector node can monitor the function output outside of a defined telecommunications channel of the directed graph. For example, the detector node can receive the function output data through a stream that is independent from the main in-band data stream of the directed graph. For instance, the detector node can be communicatively connected to the one or more function nodes over a second channel (e.g., a second frequency channel) different from the first channel (e.g., the first channel over which the one or more directed edges between the plurality of function nodes of the directed graph are defined). An out-of-band data mechanism can provide a conceptually independent channel, which can allow any data sent via that mechanism to be kept separate from in-band data. In this manner, the detector nodes can be placed, throughout the directed graph, out-of-band of hardware components and/or the directed edges of the directed graph to reduce latency, maximize flexibility, and ensure secure communications.

The detector node can be configured to detect the existence of a fault associated with the autonomous vehicle based on the function data. The detector node can be responsible for identifying and indicating a single fault. In some implementations, the detector node does not prescribe a severity of action if the fault is active, rather it is solely configured to indicate whether the fault is active and/or inactive. The plurality of detector nodes can be spread throughout the directed graph architecture anywhere a potential fault can be identified. The detector node can subscribe to as many node edges (e.g., directed edges of the directed graph architecture) as is required to make the determination of whether the fault is active.

The detector node can be configured to perform a fault detection function on the function output data to identify the existence (e.g., active state) of the fault. The fault detection function can include a boolean function, a range function, a high/low limit function, a sliding window function, and/or any other computing algorithm capable of detecting an off-nominal condition. A boolean function, for example, can be used either as a simple signal (e.g., “is the mushroom button pressed?”) or as the result of more complex evaluations from other functions (e.g., “is the camera image quality degraded?”). The range function can be used to detect whether a component is within its operational limits (e.g., “is the LiDAR operating within its specified temperature range?”). For range detection, a range can be statically defined within the range function and/or dynamically provided by another input and constrained to a reasonable limit.

In some implementations, the existence of a fault can be time dependent. In such a case, the detector node can include and/or be associated with a periodic trigger (e.g., a heartbeat trigger) and/or a global timer (e.g., defined by directed graph architecture). The periodic trigger and/or global timer can be utilized to compare the function output to a period of time. For instance, a detector node can include a sliding window function that can detect whether acceptable rates are exceeded over time (e.g., “number of dropped packets in the past second exceed a threshold,” “a high percentage of recent requests have been rejected,” etc.). The sliding window function can allow a detector node to perform calculations on time-series data: counts, sums, rates, etc. Each sliding window function can include a required time horizon and/or a sampling rate. By way of example, a counter diagnostic can be implemented as a sliding window sum function where the maximum allowable rate can be 0.

Each detector node can be configured to determine a single specific fault. For instance, a high and low function can be implemented as individual checks for high and/or low data thresholds. The fault management system can include a first detector node configured to detect whether a function output exceeds a high data threshold, a second detector node configured to detect whether a function output fails to reach a low data threshold, and/or a third detector node configured to detect whether the function output is out of range (e.g., either exceeds the high data threshold or fails to reach the low data threshold). The first, second, and third detector nodes can each be configured to obtain the same function output and detect an existence of a unique fault based on the function output.

In some implementations, multiple detector nodes can be communicatively connected to detect compound faults. A compound fault, for example, can include a fault that exists based on the existence of a plurality of sub faults. For instance, one or more sub detector nodes can be connected to an aggregator detector to check for faults only present when two or more faults (or fault conditions) are active. The faults detected by two or more different detector nodes can be logically combined (e.g., via one or more OR gates, AND gates, etc.) to detect the compound fault. By way of example, an air cleaning system can have a compressor fault in the event that: (1) the pressure is low and (2) the compressor has been on for a period of time. The fault management system can simplify the interfaces for detector nodes by including a first detector node configured to detect whether the pressure of the air cleaning system is low, and a second detector node configured to detect whether the compressor has been on for a period of time. The resulting outputs of each detector can be combined (e.g., by a third detector node) to determine whether the compressor fault is active.

The detector node can be configured to output a fault event to an associated fault handler node based on the existence of the fault (e.g., an active/inactive status of the fault) and a fault type of the detector node. A fault event, for example, can include fault status data. By way of example, each fault detection function can return fault status data. The fault status data can include a fault event identifier, a fault timestamp, a fault data timestamp, and/or a fault status indicative of whether the fault is active and/or inactive. The fault timestamp can be indicative of a time at which the fault was detected by the detector node, and the fault data timestamp can be indicative of a time at which the function output resulting in the fault was received, generated, and/or output by a respective function node.

The fault event identifier can include a unique fault identifier associated with the detector node. In some implementations, each detector node can include a unique fault identifier to distinguish between outputs of the detector nodes. By way of example, each respective detector node can be defined by a fault type. A fault type, for example, can be indicative of the nature of the fault and/or the placement of the respective detector node within the directed graph. As an example, a fault type can include a low air pressure compressor type indicating that a respective detector node is configured to obtain a function output from a compressor status parser function node (e.g., a function node configured to analyze a compressor sensor of the autonomous vehicle) and that the air pressure from the compressor is low (e.g., as indicated by function output provided by the compressor status parser function node). As another example, a fault type can include a compressor time type indicating that a respective detector node is configured to obtain function output from the compressor status parser function node and that the compressor has been running for a period of time (e.g., as indicated by function output provided by the compressor status parser function node). An additional example can include an air compressor fault type indicating that a respective detector node is configured to obtain function output from one or more sub detector nodes and that the pressure of an air cleaning system of the autonomous vehicle is low (e.g., as indicated by the function output provided by the one or more sub detector nodes).

A fault type can indicate that a detector node is connected to any function node of the plurality of function nodes of the directed graph (e.g., one or more LiDAR sensor parser function nodes, a trajectory function node, etc.). Moreover, each fault type can indicate a specific fault associated with the autonomous vehicle (e.g., low air pressure, loss of data, corrupted messages, etc.). In some implementations, each fault type can be associated with a fault severity. The fault severity can be indicative of a level of severity of a fault detected by a respective detector node.

A fault severity can correspond to a respective fault severity level of a plurality of predefined fault severity levels. By way of example, the plurality of predefined fault severity levels can include an emergency fault level, a transition fault level, an unaware stop fault level, an aware stop fault level, a designated park fault level, a maintenance fault level, among other fault severity levels indicative of a respective severity of one or more fault types. Each of the defined levels can range from most severe to least severe. For instance, an emergency fault level can be the most severe fault severity level. In addition, or alternatively, the maintenance level can be the least severe fault severity level.

As described herein, the plurality of function nodes of the directed graph architecture can include a plurality of fault handler nodes. In some implementations, the plurality of fault handler nodes can include a respective node for each fault severity level of the plurality of predefined fault severity levels. By way of example, the plurality of fault handler nodes can include an emergency node, a transition node, an unaware stop node, an aware stop node, a designated park node, and/or a maintenance node. In this manner, a fault handler node can be associated with a respective fault severity. The fault handler node can be configured to handle all faults detected by a detector node of a fault type associated with the respective fault severity.

More particularly, each respective detector node of the plurality of detector nodes can be associated with a fault handler node of the plurality of fault handler nodes. For example, each detector node can be configured to output data to an associated fault handler node (e.g., via the connected edge) based on the fault type of the detector node. For instance, each fault type of the plurality of fault types can correspond to a fault severity as indicated by a directed edge of the directed graph. The directed edge, for example, can connect a detector node defined by a respective fault type to a respective fault handler node configured to handle faults of a respective severity level. By connecting the detector node defined by the respective fault type to the respective fault handler node, the directed edge can indicate that the respective fault type is associated with the respective severity level corresponding to the respective fault handler node. By way of example, a detector node connected, via a directed edge, to an emergency node can be defined by a fault type associated with an emergency fault level. In this manner, the configuration of edges between the plurality of detector nodes and the plurality of fault handler nodes of the fault management system can determine the severity level associated with a fault type defining each of the plurality of respective detector nodes.

A fault handler node can be configured to obtain a fault event based on the fault type of a respective detector node and initiate a fault response for the autonomous vehicle based at least in part on the fault event. A fault response can include one of a plurality of fault responses. The plurality of fault responses can include one or more filtering responses and/or vehicle responses. The vehicle response(s) can include a stop in a current travel way of the autonomous vehicle, a stopping maneuver to move the autonomous vehicle out of the travel way, a transition from an autonomous state to a manual state, a parking maneuver at a designated area, a navigation to a maintenance facility, and/or any other vehicle action to safely handle a fault.

Each respective fault handler node can be associated with a respective fault response that corresponds to the fault severity associated with the respective fault handler node. By way of example, an emergency node can be associated with a stop in a current travel way of the autonomous vehicle, a transition node can be associated with a transition from an autonomous state to a manual state, an unaware stop node can be associated with a stopping maneuver to move the autonomous vehicle out of the travel way, an aware stop node can be associated with another stopping maneuver to move the autonomous vehicle out of the travel way after clearing an obstacle, a designated park node can be associated with a parking maneuver at a designated area, and/or a maintenance node can be associated with a navigation to a maintenance facility.

The graph architecture of the autonomous vehicle can also include a plurality of action function nodes. The plurality of action function nodes can be configured to cause the performance of one or more vehicle actions. For instance, each action function node can be configured to cause the performance of a respective vehicle action. As an example, an action function node can include a trajectory generation node configured to generate a vehicle trajectory. The trajectory generation node can be configured to cause an autonomous vehicle to follow a respective trajectory by generating the respective trajectory and providing the respective trajectory to a motion planning node. As another example, an action function node can include a motion planning node configured to generate a motion plan for the autonomous vehicle. The motion planning node can be configured to cause an autonomous vehicle to implement a respective motion plan (e.g., to a designated parking location) by generating the respective motion plan and providing the respective motion plan to a vehicle control system. In this manner, each action function node of the plurality of action function nodes can be associated with a vehicle response of the one or more vehicle responses. For instance, a respective action function node can cause the performance of a vehicle action corresponding to a vehicle response.

Each fault handler node can be communicatively connected to at least one action function node. By way of example, in some implementations, each fault handler node can be placed in-line with the directed graph architecture relative to at least one action function node. For instance, a respective fault handler node can be communicatively connected, over the first channel, to a respective action function node. The respective action function node, for example, can be configured to cause the performance of a vehicle action corresponding to a respective fault response associated with the respective fault handler node. In this manner, the respective fault handler node can initiate a vehicle response for the autonomous vehicle based on a fault event by communicating with the action function node configured to cause the performance of the vehicle response.

To do so, in some implementations, each fault handler node can be configured to control the flow of data within the directed graph. By way of example, the one or more fault responses can include one or more filter responses. Each filter response can initiate, modify, and/or have no effect on a vehicle action caused by a respective action function node. A fault handler node can receive a plurality of messages directed to the respective action function node and perform a filter response before the message reaches the action function node. For example, the fault handler node can permit the normal flow of traffic by providing one or more of the plurality of messages to the respective action function node, block one or more of the plurality of the messages from the action function node, and/or communicate a safety message to the action function node, for example, by flagging a message and forwarding the message the action function node. The safety message, for example, can initiate a respective vehicle response associated with the fault handler node. In this manner, each fault handler node can be configured to control which messages are received by a respective action function node of the directed graph by initiating a filter response.

As an example, a fault handler node communicatively connected to a motion planning node can receive a plurality of messages addressed to the motion planning node such as, for example, one or more trajectory messages. The fault handler node can stop a trajectory message from reaching the motion planning node, forward the message to the motion planning node, and/or modify the message (e.g., by flipping a flag indicative of a command, modifying an input value, etc.) and forward the modified message to the motion planning node, for example, to initiate a vehicle response.

The fault handler node can initiate a fault response (e.g., filter response and/or vehicle response) based on a fault event. For instance, a fault handler node can be configured to block and/or communicate one or more messages to the respective action function node based on the fault event. For example, the fault handler node can store a fault status indicative of the existence of a fault. The fault handler node can update the fault status based on the fault event. The fault handler node can determine a fault response for one or more messages based on the fault status. For instance, the fault handler node can initiate a blocking filter response and/or initiate a vehicle response in the event the fault status is active. In addition, or alternatively, the fault handler node can initiate a permission filter response in the event that the fault status is inactive.

In some implementations, the fault handler node can receive multiple fault events (e.g., first fault event, second fault event, etc.) indicative of multiple faults (e.g., first fault, second fault, etc.) from multiple detector nodes (e.g., first detector node, second detector node, etc.) associated with the fault handler node. In such a case, the fault handler node can determine a prioritization of the multiple faults (e.g., first fault, second fault, etc.) based on the multiple fault events (e.g., the first fault event, second fault event, etc.). By way of example, the first fault can be indicative of a reoccurring air compressor fault indicative of a faulty air compressor sensor. A fault handler node can receive a fault event indicative of the first fault and prioritize other faults, such as a second fault indicative of a new faulty LiDAR sensor fault, over the first fault because the first fault is expected (e.g., reoccurring).

In addition, or alternatively, the fault handler node can initiate a fault response based on a fault event and a context of the vehicle computing system of that autonomous vehicle. The context of the vehicle computing system can be indicative of a state of the vehicle computing system. For instance, the context of the vehicle computing system can include a vehicle operating mode (e.g., manual, semi-autonomous, autonomous, etc.) of the vehicle computing system. The fault handler node can obtain state data indicative of the state of the vehicle computing system and can initiate the fault response based at least in part on the state. For instance, the fault handler node can compare the fault event to the state data to determine the fault response. By way of example, if the fault handler node is communicatively connected to a motion planner node and receives a fault event indicative of a faulty trajectory, the fault handler node can block the faulty trajectory from the motion planner node in the event the vehicle computing system is in a manual driving mode and initiate a vehicle response (e.g., a safe stop) in the event the vehicle computing system is in an autonomous driving mode.

The fault handler node can be included in-line with the directed graph architecture where the fault event is expected to affect the execution of the directed graph. In this manner, the fault management system allows explicit connections between faults and vehicle actions. By placing the fault handler nodes in this manner, the fault management system eliminates the need to send fault responses across devices/containers/process boundaries, etc. of a vehicle computing system. Moreover, the fault handlers can be placed based on importance (e.g., the severity level associated with the fault handler). For example, a first fault handler (e.g., an emergency node) configured to handle more severe fault levels (e.g., faults associated with an emergency fault level) can be placed with respect to a vehicle control system, thereby enabling the fault handler to directly cause a motion of the vehicle (e.g., an emergency stop). In addition, a second fault handler (e.g., a maintenance node) configured to handle less severe fault levels (e.g., faults of a maintenance fault level) can be placed with respect to a trajectory generation node, thereby enabling the fault handler to directly cause the generation of a safety trajectory. In this manner, in the event that a maintenance fault and an emergency fault occur simultaneously, the directed graph with generate a safety trajectory (e.g., in response to the maintenance fault), but ultimately perform an emergency stop (e.g., in response to the emergency fault).

As discussed herein, a vehicle computing system of the autonomous vehicle can be configured to run one or more processes by executing a respective subset of function nodes for each respective process of the one or more processes. In some implementations, a detector node can be associated with a first process (e.g., connected to a function node of the first function graph) of the directed graph and the associated fault handler node can be associated with a second process (e.g., connected to an action function node of a second function graph) of the directed graph. The fault management system can utilize one or more per-level filters at the one or more processes (e.g., the first function graph and/or the second function graph) to propagate fault information between the detector and associated fault handler. For instance, the one or more per-level filters can act as an OR gate between a plurality of faults signals of a process. For example, each process of the one or more processes can include a plurality of per-level filters. Each respective per-level filter of the plurality of per-level filters can correspond to a fault handler node of the plurality of fault handler nodes. For instance, each respective per-level filter of the plurality of per-level filters can forward a respective fault event to a respective fault handler node.

Each detector node for a respective process can be communicatively connected to a respective per-level filter of the respective process. Outputs (e.g., fault events) from each detector node can be wired into a filter function of a respective per-level filter. The detector node can be communicatively connected to the respective per-level filter based, at least in part, on the fault type of the detector node. For example, the detector node can be communicatively connected to a per-level filter corresponding to a fault handler configured to handle fault events of the fault type of the detector node.

A per-level filter can be configured to obtain a fault event from a respective detector node, apply a filter logic to the fault event, and communicate the fault event to a respective fault handler node based at least in part on the filter logic. The filter logic, for example, can be configured to determine that the fault event includes a unique fault status different than a fault status of a previous fault event that was previously obtained by the per-level filter. For instance, the per-level filter can be configured to communicate the fault event to the respective fault handler node in response to determining that the fault event includes the unique fault status and ignore the fault event in response to determining that the fault event does not include a unique fault status. In the event that the per-level filter corresponds to a fault handler node within the same process, the per-level filter can output the fault event directly to the fault handler node. In the event that the per-level filter corresponds to a fault handler node running in a different process, the per-level filter can output the fault event to a local per-level filter corresponding to the fault handler node within the different process. In this manner, per-level filters at each process can limit redundant network traffic across processes.

Example aspects of the present disclosure can provide a number of improvements to fault management technology and robotics computing technology such as, for example, fault management technology for autonomous vehicles. For instance, the systems and methods of the present disclosure can provide an improved approach for managing faults associated with an autonomous vehicle computing system. For example, a vehicle computing system can include a plurality of function nodes arranged in a directed graph architecture. The plurality of function nodes can include a plurality of detector nodes defined by a fault type and a plurality of fault handler nodes. Each respective detector node can be associated with a fault handler node. The vehicle computing system can obtain, by a detector node, function data from one or more function nodes of the plurality of function nodes. The vehicle computing system can detect, by the detector node, an existence of a fault associated with an autonomous vehicle based, at least in part, on the function data. The computing system can output, by the detector node to an associated fault handler node, a fault event indicative of the existence of the fault and the fault type of the respective detector node. And, the computing system can initiate, by the associated fault handler node, a fault response for the autonomous vehicle based, at least in part, on the fault event. In this manner, the present disclosure presents an improved computing system that can effectively manage faults associated with an autonomous vehicle. The computing system employs improved fault management techniques that leverage a directed graph architecture and multiple single function nodes within the directed graph architecture to reduce the time from detection to reaction of a fault. As a result, the computing system provides the practical application of increasing vehicle safety, generally, and autonomous vehicle safety, in particular, by efficiently identifying and responding to faults within an autonomous vehicle.

Moreover, by utilizing multiple, redundant, vehicle response specific fault handlers, the fault management system of the present disclosure can provide a more reliable and scalable solution for handling fault in robust computing systems. The fault management system can accumulate and utilize newly available information such as, for example, specific fault identifiers (e.g., fault types defining each fault detector) and directed edges defining the relationship between a fault identifier and a severity level to create explicit connections between low level faults and high level vehicle actions. This, in turn, improves the functioning of fault management systems in general by decreasing simplifying fault handling. Ultimately, the fault management techniques disclosed herein result in improved vehicle reactions to internal/external faults; thereby increasing road-way safety.

Furthermore, although aspects of the present disclosure focus on the application of fault management techniques described herein to vehicle computing systems utilized in autonomous vehicles, the systems and methods of the present disclosure can be used to manage faults on any computing system. Thus, for example, the systems and methods of the present disclosure can be used to detect, and handle faults based on the aspects any type of computing system.

Various means can be configured to perform the methods and processes described herein. For example, a computing system can include data obtaining unit(s), detection unit(s), generation unit(s), data providing unit(s), response unit(s), action unit(s) and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s), etc.) can be configured to obtain a function data from one or more function nodes of a plurality of function nodes arranged in a directed graph architecture. The means (e.g., detection unit(s), etc.) can be configured to detect an existence of a fault associated with an autonomous vehicle based on the function data. The means (e.g., generation unit(s), etc.) can be configured to generate a fault event based on the existence of the fault.

The means (e.g., data providing unit(s), etc.) can output the fault event indicative of the existence of the fault and a fault type of a detector node of the plurality of function nodes that detected the fault. The means (e.g., response unit(s), etc.) can initiate a fault response for the autonomous vehicle based on the fault event. The means (e.g., action unit(s), etc.) can initiate a vehicle action in response to the fault response.

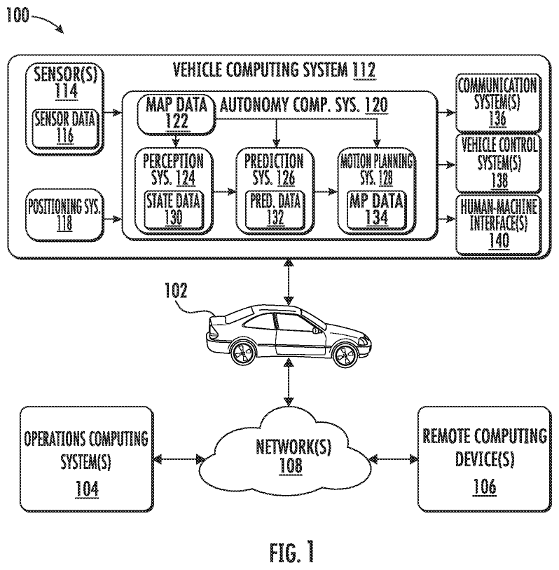

With reference now to FIGS. 1-10, example embodiments of the present disclosure will be discussed in further detail. FIG. 1 depicts an example system 100 overview according to example implementations of the present disclosure. More particularly, FIG. 1 illustrates a vehicle 102 (e.g., an autonomous vehicle, etc.) including various systems and devices configured to control the operation of the vehicle. For example, the vehicle 102 can include an onboard vehicle computing system 112 (e.g., located on or within the vehicle) that is configured to operate the vehicle 102. Generally, the vehicle computing system 112 can obtain sensor data 116 from a sensor system 114 onboard the vehicle 102, attempt to comprehend the vehicle's surrounding environment by performing various processing techniques on the sensor data 116, and generate an appropriate motion plan 134 through the vehicle's surrounding environment.

As illustrated, FIG. 1 shows a system 100 that includes the vehicle 102; a communications network 108; an operations computing system 104; one or more remote computing devices 106; the vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can be configured to monitor and communicate with the vehicle 102 and/or its users to coordinate a vehicle service provided by the vehicle 102. To do so, the operations computing system 104 can communicate with the one or more remote computing devices 106 and/or the vehicle 102 via one or more communications networks including the communications network 108. The communications network 108 can send and/or receive signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. the Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including sending and/or receiving data or signals to and from the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices. The remote computing device(s) 106 can be remote from the vehicle computing system 112. The remote computing device(s) 106 can include, for example, one or more operator devices associated with one or more vehicle operators, user devices associated with one or more vehicle passengers, developer devices associated with one or more vehicle developers (e.g., a laptop/tablet computer configured to access computer software of the vehicle computing system 112), etc. As used herein, a device can refer to any physical device and/or a virtual device such as, for example, compute nodes, computing blades, hosts, virtual machines, etc. One or more of the devices can receive input instructions from a user or exchange signals or data with an item or other computing device or computing system (e.g., the operations computing system 104).

In some implementations, the one or more remote computing devices 106 can be used to determine and/or modify one or more states of the vehicle 102 including a location (e.g., a latitude and longitude), a velocity, an acceleration, a trajectory, a heading, and/or a path of the vehicle 102 based in part on signals or data exchanged with the vehicle 102. In some implementations, the operations computing system 104 can include the one or more of the remote computing devices 106.

The one or more remote computing devices 106 can be associated with a service entity configured to facilitate a vehicle service. The one or more remote devices can include, for example, one or more operations computing devices of the operations computing system 104 (e.g., implementing back-end services of the platform of the service entity's system), one or more operator devices configured to facilitate communications between a vehicle and an operator of the vehicle (e.g., an onboard tablet for a vehicle operator, etc.), one or more user devices configured to facilitate communications between the service entity and/or a vehicle of the service entity with a user of the service entity (e.g., an onboard tablet accessible by a rider of a vehicle, etc.), one or more developer computing devices configured to provision and/or update one or more software and/or hardware components of the plurality of vehicles (e.g., a laptop computer of a developer, etc.), one or more bench computing devices configured to generate benchmark statistics based on metrics collected by the vehicle 102, one or more simulation computing devices configured to test (e.g., debug, troubleshoot, annotate, etc.) one or more components of the plurality of vehicles, etc.

The vehicle 102 can be a ground-based vehicle (e.g., an automobile, a motorcycle, a train, a tram, a bus, a truck, a tracked vehicle, a light electric vehicle, a moped, a scooter, and/or an electric bicycle), an aircraft (e.g., airplane, vertical take-off and lift aircraft, or helicopter), a boat, a submersible vehicle (e.g., a submarine), an amphibious vehicle, a hovercraft, a robotic device (e.g. a bipedal, wheeled, or quadrupedal robotic device), and/or any other type of vehicle. The vehicle 102 can be an autonomous vehicle that can perform various actions including driving, navigating, and/or operating, with minimal and/or no interaction from a human driver. The vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

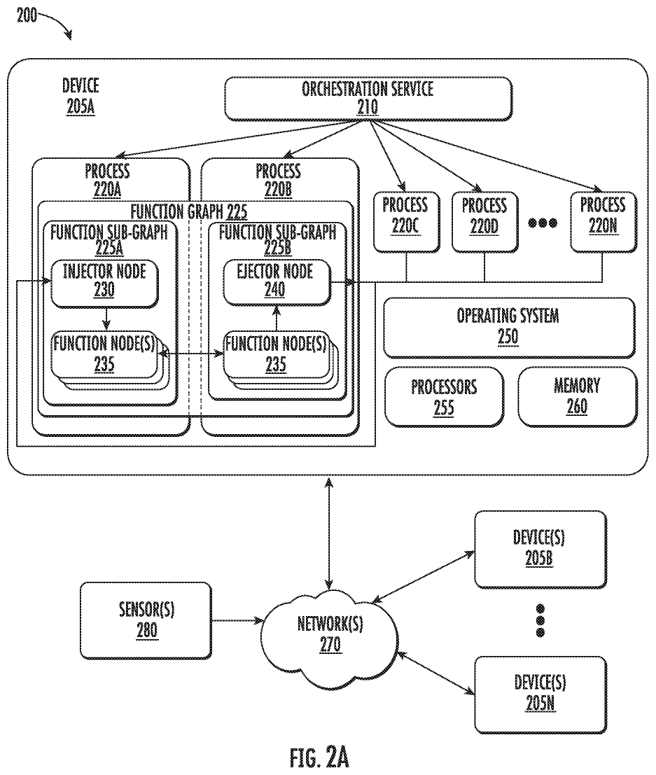

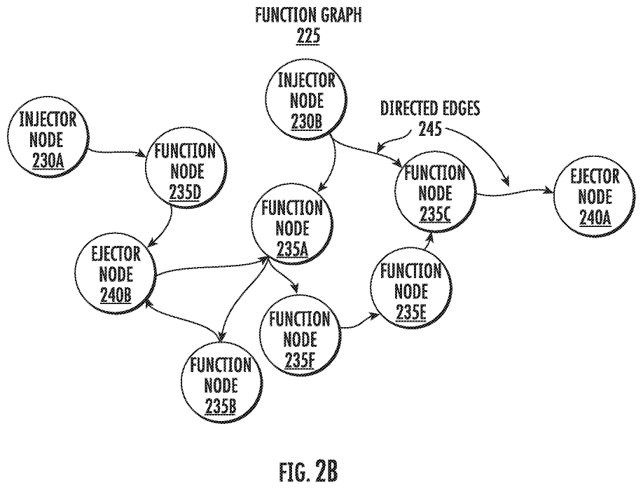

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. As discussed in further detail with reference to FIGS. 2A-B, the one or more computing devices of the vehicle computing system 112 can include various components for performing various operations and functions. For instance, the one or more computing devices of the vehicle computing system 112 can include one or more processors and one or more tangible non-transitory, computer readable media (e.g., memory devices). The one or more tangible non-transitory, computer readable media can store instructions that when executed by the one or more processors cause the vehicle 102 (e.g., its computing system, one or more processors, and other devices in the vehicle 102) to perform operations and/or functions, including those described herein for managing faults within a computing system.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 102 (e.g., within range or a field of view of one or more of the one or more sensors 114). The one or more sensors 114 can include one or more Light Detection and Ranging (LiDAR) systems, one or more Radio Detection and Ranging (RADAR) systems, one or more cameras (e.g., visible spectrum cameras and/or infrared cameras), one or more sonar systems, one or more motion sensors, and/or other types of image capture devices and/or sensors. The sensor data 116 can include image data, radar data, LiDAR data, sonar data, and/or other data acquired by the one or more sensors 114. The one or more objects can include, for example, pedestrians, vehicles, bicycles, buildings, roads, foliage, utility structures, bodies of water, and/or other objects. The one or more objects can be located on or around (e.g., in the area surrounding the vehicle 102) various parts of the vehicle 102 including a front side, rear side, left side, right side, top, or bottom of the vehicle 102. The sensor data 116 can be indicative of locations associated with the one or more objects within the surrounding environment of the vehicle 102 at one or more times. For example, sensor data 116 can be indicative of one or more LiDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and/or location of different roadways, road segments, buildings, or other items or objects (e.g., lampposts, crosswalks and/or curbs); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine a position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing devices 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the sensor data 116 (e.g., LiDAR data, camera data) to match it to a map of the surrounding environment to get a determination of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment, including for example, a motion plan that navigates the vehicle 102 around the current and/or predicted locations of one or more objects detected by the one or more sensors 114. The autonomy computing system 120 can control the one or more vehicle control systems 138 to operate the vehicle 102 according to the motion plan.

The autonomy computing system 120 can identify one or more objects that are proximate to the vehicle 102 based at least in part on the sensor data 116 and/or the map data 122. For example, the perception system 124 can obtain state data 130 descriptive of a current and/or past state of an object that is proximate to the vehicle 102. The state data 130 for each object can describe, for example, an estimate of the object's current and/or past: location and/or position; speed; velocity; acceleration; heading; orientation; size/footprint (e.g., as represented by a bounding shape); class (e.g., pedestrian class vs. vehicle class vs. bicycle class), and/or other state information. The perception system 124 can provide the state data 130 to the prediction system 126 (e.g., for predicting the movement of an object).

The prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128. In some implementations, the perception and prediction systems 124, 126 (and/or other systems) can be combined into one system and share computing resources.

In some implementations, the prediction system 126 can utilize one or more machine-learned models. For example, the prediction system 126 can determine prediction data 132 including a predicted trajectory (e.g., a predicted path, one or more predicted future locations, etc.) along which a respective object is predicted to travel over time based on one or more machine-learned models. By way of example, the prediction system 126 can generate such predictions by including, employing, and/or otherwise leveraging a machine-learned prediction generator model. For example, the prediction system 126 can receive state data 130 (e.g., from the perception system 124) associated with one or more objects within the surrounding environment of the vehicle 102. The prediction system 126 can input the state data 130 (e.g., BEV image, LIDAR data, etc.) into the machine-learned prediction generator model to determine trajectories of the one or more objects based on the state data 130 associated with each object. For example, the machine-learned prediction generator model can be previously trained to output a future trajectory (e.g., a future path, one or more future geographic locations, etc.) of an object within a surrounding environment of the vehicle 102. In this manner, the prediction system 126 can determine the future trajectory of the object within the surrounding environment of the vehicle 102 based, at least in part, on the machine-learned prediction generator model.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections). In some implementations, the communications system 136 can allow communication among one or more of the system on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

By way of example, the communications system 136 can include one or more communication interfaces configured to communicate with the one or more remote computing devices 106, the operations computing system 104, etc. In addition, or alternatively, the communications system 136 can include one or more communication interfaces configured to communicate messages between one or more internal nodes and/or processes running within by the vehicle computing system 112. The communication interfaces can include, for example, one or more wired communication interfaces (e.g., USB, Ethernet, FireWire, etc.), one or more wireless communication interfaces (e.g., Zigbee wireless technology, Wi-Fi, Bluetooth, etc.), etc. For example, the communication interfaces can establish communications over one or more wireless communication channels (e.g., via local area networks, wide area networks, the Internet, cellular networks, mesh networks, etc.). The one or more channels can include one or more encrypted and/or unencrypted channels. The channels, for instance, can include gRPC messaging. For instance, in some implementations, the channels can include unencrypted channels, encrypted using one or more cryptographic signing techniques (e.g., symmetric signing, asymmetric signing, etc.).

The vehicle computing system 112 can receive and/or provide a plurality of messages, via the one or more communication interfaces, from/to the one or more devices (e.g., of the vehicle computing system 112, the operations computing system 104, remote computing devices 106, remote devices associated with the service entity, etc.). For example, as discussed herein with reference to FIGS. 2A-B, the system 100 (e.g., vehicle computing system 112, operations computing system 104, remote computing device 106, etc.) can include a plurality of processes running on a plurality of devices (vehicle devices of the vehicle computing system 112, remote device remote from the vehicle computing system 112) of the system 100. The plurality of processes can be collectively configured to perform one or more tasks or services of the system 100, for example, as requested by a message.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat). For example, the autonomy computing system 120 can provide one or more outputs including a graphical display of the location of the vehicle 102 on a map of a geographical area within one kilometer of the vehicle 102 including the locations of objects around the vehicle 102. A passenger of the vehicle 102 can interact with the one or more human-machine interfaces 140 by touching a touchscreen display device associated with the one or more human-machine interfaces to indicate, for example, a stopping location for the vehicle 102.

In some embodiments, the vehicle computing system 112 can perform one or more operations including activating, based at least in part on one or more signals or data (e.g., the sensor data 116, the map data 122, the state data 130, the prediction data 132, and/or the motion plan data 134) one or more vehicle systems associated with operation of the vehicle 102. For example, the vehicle computing system 112 can send one or more control signals to activate one or more vehicle systems that can be used to control and/or direct the travel path of the vehicle 102 through an environment.

By way of further example, the vehicle computing system 112 can activate one or more vehicle systems including: the communications system 136 that can send and/or receive signals and/or data with other vehicle systems, other vehicles, or remote computing devices (e.g., remote server devices); one or more lighting systems (e.g., one or more headlights, hazard lights, and/or vehicle compartment lights); one or more vehicle safety systems (e.g., one or more seatbelt and/or airbag systems); one or more notification systems that can generate one or more notifications for passengers of the vehicle 102 (e.g., auditory and/or visual messages about the state or predicted state of objects external to the vehicle 102); braking systems; propulsion systems that can be used to change the acceleration and/or velocity of the vehicle which can include one or more vehicle motor or engine systems (e.g., an engine and/or motor used by the vehicle 102 for locomotion); and/or steering systems that can change the path, course, and/or direction of travel of the vehicle 102.

The following describes the technology of this disclosure within the context of an autonomous vehicle for example purposes only. As described herein, the technology of the present disclosure is not limited to an autonomous vehicle and can be implemented within other robotic and/or other computing systems, such as those managing messages from a plurality of disparate processes.

As an example, the system 100 of the present disclosure can include any combination of the vehicle computing system 112, one or more subsystems and/or components of the vehicle computing system 112, one or more remote computing systems such as the operations computing system 104, one or more components of the operations computing system 104, and/or other remote computing devices 106. For example, each vehicle sub-system can include one or more vehicle device(s) and each remote computing system/device can include one or more remote devices. The plurality of devices of the system 100 can include one or more of the one or more vehicle device(s) (e.g., internal devices) and/or one or more of the remote device(s).

FIG. 2A depicts a diagram of an example computing system 200 including one or more of the plurality of devices (e.g., plurality of devices 205A-N) of the computing system of the present disclosure. The plurality of devices 205A-N can include one or more devices configured to communicate over one or more wired and/or wireless communication channels (e.g., wired and/or wireless networks). Each device (e.g., 205A) can be associated with a type, an operating system 250, and/or one or more designated tasks. A type, for example, can include an indication of the one or more designated tasks of a respective device 205A. The one or more designated tasks, for example, can include performing one or more processes 220A-N and/or services of the computing system 200.

Each device 205A of the plurality of devices 205A-N can include and/or have access to one or more processors 255 and/or one or more memories 260 (e.g., RAM memory, ROM memory, cache memory, flash memory, etc.). The one or more memories 260 can include one or more tangible non-transitory computer readable instructions that, when executed by the one or more processors 255, cause the device 205A to perform one or more operations. The operations can include, for example, executing one or more of a plurality of processes of the computing system 200. For instance, each device 205A can include a compute node configured to run one or more processes 220A-N of the plurality of processes.

For example, the device 205A can include an orchestration service 210. The orchestration service 210 can include a start-up process of the device 205A. The orchestration service 210, for example, can include an operating system service (e.g., a service running as part of the operating system 250). In addition, or alternatively, the orchestration service can include a gRPC service. The device 205A can run the orchestration service 210 to configure and start processes 220A-220N of the device 205A. In some implementations, the orchestration service 210 can include a primary orchestrator and/or at least one of a plurality of secondary orchestrators. For example, each respective device of the plurality of devices can include at least one of the plurality of secondary orchestrators. The primary orchestrator can be configured to receive global configuration data and provide the global configuration data to the plurality of secondary orchestrators. The global configuration data, for example, can include one or more instructions indicative of the one or more designated tasks for each respective device(s) 205A-N, a software version and/or environment on which to run a plurality of processes (e.g., 220A-220N of the device 205A) of the computing system 200, etc. A secondary orchestrator for each respective device can receive the global configuration data and configure and start one or more processes at the respective device based on the global configuration data.

For instance, each process (e.g., process 220A, 220B) can include a plurality of function nodes 235 (e.g., pure functions) connected by one or more directed edges that dictate the flow of data between the plurality of function nodes 235. Each device 205A can execute (e.g., via one or more processors, etc.) a respective plurality of function nodes 235 to run a respective process 220A, 220B. For example, the plurality of function nodes 235 can be arranged in one or more function graphs 225. A function graph 225 can include a plurality of (e.g., series of) function nodes 235 arranged (e.g., by one or more directed edges) in a pipeline, graph architecture, etc.

For example, with reference to FIG. 2B, FIG. 2B depicts a diagram of an example functional graph 225 according to example implementations of the present disclosure. The function graph 225 can include a plurality of function nodes 235A-F, one or more injector nodes 230A-B, one or more ejector nodes 240A-B, and/or one or more directed edges 245. The function nodes 235 can include one or more computing functions with one or more inputs (e.g., of one or more data types) and one or more outputs (e.g., of one or more data types). For example, the function nodes 235A-F can be implemented such that they define one or more accepted inputs and one or more outputs. In some implementations, each function node 235A-F can be configured to obtain one or more inputs of a single data type, perform one or more functions on the one or more inputs, and output one or more outputs of a single data type.

Each function node of the plurality of function nodes 235A-F can be arranged in a directed graph architecture (e.g., including a plurality of function graphs) and can be configured to obtain function input data associated with an autonomous vehicle based on the one or more directed edges 245 (e.g., of the directed graph 225). For instance, the function nodes 235A-F can be connected by one or more directed edges 245 of the function graph 225 (and/or a subgraph 225A, 225B of the function graph 225 with reference to FIG. 2A). The one or more directed edges 245 can dictate how data flows through the function graph 225 (and/or the subgraphs 225A, 225B of FIG. 2A). For example, the one or more directed edges 245 can be formed based on the defined inputs and outputs of each of the function nodes 235A-F of the function graph 225. The function nodes 235A-F can generate function output data based on the function input data. For instance, the function nodes 235A-F can perform one or more functions of the autonomous vehicle on the function input data to obtain the function output data. The function nodes 235A-F can communicate the function output data to one or more other function nodes of the plurality of function nodes 235A-F based on the one or more directed edges 245 of the directed graph 225.

In addition, or alternatively, each function graph 225 can include one or more injector nodes 230A-B and one or more ejector nodes 220A-B configured to communicate with one or more remote devices and/or processes (e.g., processes 220C-220N of FIG. 2A) outside the function graph 225. The injector nodes 230A-B, for example, can be configured to communicate with one or more devices and/or processes (e.g., processes 220C-220N of FIG. 2A) outside the function graph 225 to obtain input data for the function graph 225. By way of example, each of the one or more injector nodes 230A-B can include a function configured to obtain and/or process sensor data from a respective sensor 280 shown in FIG. 2A (e.g., sensor(s) 114 of FIG. 1). The ejector nodes 240A-B can be configured to communicate with one or more devices 205B-N and/or processes 220C-220N outside the function graph 225 to provide function output data of the function graph 225 to the one or more devices 205B-N and/or processes 220C-220N.

Turning back to FIG. 2A, each device 205A-N can be configured to execute one or more function graphs 225 to run one or more processes 220A, 220B of the plurality of processes 220A-N of the respective device 205A. For example, as described herein, each respective device can be configured to run a respective set of processes based on global configuration data. Each process 220A-N can include an executed instance of a function graph and/or a subgraph of a function graph. For example, in some implementations, a function graph 225 can be separated across multiple processes 220A, 220B. Each process 220A, 220B can include a subgraph 225A, 225B (e.g., process 220A including subgraph 225A, process 220B including subgraph 225B, etc.) of the function graph 225. In such a case, each process 220A, 220B of the function graph 225 can be communicatively connected by one or more function nodes 235 of the function graph 225. In this manner, each respective device 205A-N can be configured to run a respective process by executing a respective function graph and/or a subgraph of the respective function graph. Thus, each function graph can be implemented as a single process or multiple processes.

In some implementations, one or more of the plurality of processes 220A-N can include containerized services (application containers, etc.). For instance, each process 220A-N can be implemented as a container (e.g., docker containers, etc.). For example, the plurality of processes 220A-N can include one or more containerized processes abstracted away from an operating system 250 associated with each respective device 205A. As an example, the containerized processes can be run in docker containers, such that each process is run and authorized in isolation. For example, each respective container can include one or more designated computing resources (e.g., processing power, memory locations, etc.) devoted to processes configured to run within the respective container. Moreover, in some implementations, each container can include an isolated runtime configuration (e.g., software model, etc.). In this manner, each container can independently run processes within a container specific runtime environment.

The plurality of devices 205A-N, sensors 280, processes 220A-N, etc. of the computing system 200 (e.g., the plurality of processes of the vehicle computing system 112, a plurality of processes of the one or more remote devices, etc.) can be communicatively connected over one or more wireless and/or wired networks 270. For instance, the plurality of devices 205A-N (and/or processes 220A-N of device 205A) can communicate over one or more communication channels 270. Each device and/or process can exchange messages over the one or more communicative channels using a message interchange format (e.g., JSON, IDL, etc.). By way of example, a respective process can utilize one or more communication protocols (e.g., HTTP, REST, gRPC, etc.) to provide and/or receive messages from one or more respective device processes (e.g., other processes running on the same device) and/or remote processes (e.g., processes running on one or more other devices of the computing system). In this manner, devices can be configured to communicate messages between one or more devices, services, and/or other processes to carry out one or more tasks. The messages, for example, can include function output data associated with a respective function node (e.g., 235).

At times, the function output data can be indicative of the existence of one or more faults associated with the autonomous vehicle. By way of example, a function node 235 can include a compressor status parser function node configured to receive input function data from an air compressor sensor (e.g., sensor 280). The compressor status parser function node can perform a parser function on the input function data to determine an air pressure for an air compressor of the autonomous vehicle. The compressor status parser function node can output function output data indicative of the air pressure of the air compressor to one or more function nodes 235 of the directed function graph 225. The output function data can be indicative of the existence of one or more faults in the event that the air pressure is abnormal.

For example, a fault can be indicative of an off-nominal condition that can lead to a system or part of a system failure. A system failure can include an unacceptable performance of system software (e.g., a function node of the directed graph, etc.), system hardware (e.g., a sensor, air compressor, etc.), and/or any other portion of the system. The existence of a fault can be indicative of an active state of a respective off-nominal condition. By way of example, a fault can indicate a hardware failure such as low air pressure in an air filtering system, etc. and/or a software failure such as the blocking of an execution of a process, a deadlock, a livelock, an incorrect allocation of execution time, an incorrect synchronization between software elements (e.g., function nodes 235 of the directed graph 225), a corruption of message content, an unauthorized read/write access to memory allocated to another software element, a repetition of information, a loss of information, a delay of information, an unauthorized insertion of information, a masquerade or incorrect addressing of information, an incorrect sequence of information, and/or an otherwise corruption of information, etc.

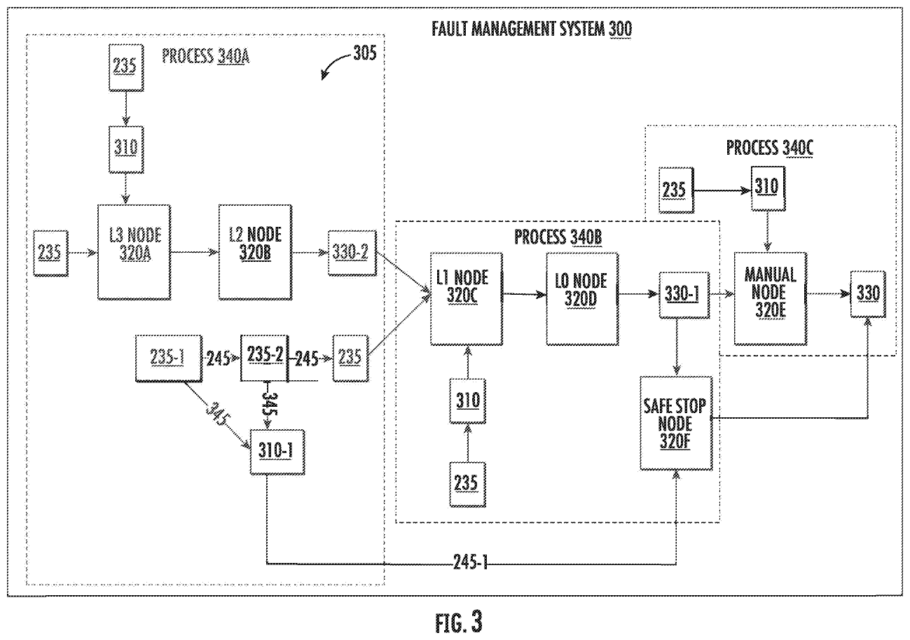

The present disclosure is directed to a vehicle fault management system to detect and handle such faults. For example, FIG. 3 depicts an example fault management system 300 according to example implementations of the present disclosure. In some implementations, the fault management system 300 can be integrated within an autonomous vehicle (e.g., an autonomy system 120, vehicle computing system 112, etc. of the autonomous vehicle 102). For instance, the vehicle fault management system 300 can include a security infrastructure for the vehicle. The vehicle fault management system 300 can include the plurality of function nodes 235 arranged in a directed graph architecture, as described herein with reference FIGS. 2A-2B. For instance, the directed graph architecture can define a directed graph 305 including a plurality of function nodes 235, 310, 320A-F, 330 arranged in one or more function graphs (e.g., processes 340A-C), each function node of the one or more function graphs can be connected by a directed edge 245 as prescribed by the directed graph architecture. The function nodes 235 can perform functions that are associated with the operation of the autonomous vehicle (e.g., processing sensor data, determining object trajectories, analyzing hardware performance, etc.). The plurality of function nodes 235 can include a plurality of detector nodes 310, a plurality of fault handler nodes 320A-F, and a plurality of vehicle action nodes 330. Each detector node 310 can be defined by a fault type and can be associated with a respective fault handler node (e.g., based on the fault type) of the fault handler nodes 320A-F.

More particularly, the plurality of function nodes 235 can include a plurality of detector nodes 310 placed throughout the directed graph 305. An example detector node 310-1 can be configured to obtain function data (e.g., function output data) from one or more function nodes (e.g., 235-1, 235-2) of the plurality of function nodes 235 of the directed graph 305. For example, a detector node can include a computing function (e.g., a pure function) subscribed to the data outputs of one or more function nodes. The detector node 310-1 can be configured to monitor the function output provided by each of the one or more function nodes (e.g., 235-1, 235-2). As an example, a detector node can be configured to detect a LIDAR sensor temperature fault (e.g., the LIDAR operating outside its specified temperature range) based on data from LIDAR system temperature data provided via one or more functions nodes associated with the LIDAR system. The plurality of detector nodes 310 can be spread throughout the directed graph 305 anywhere a potential fault can be identified. The detector nodes 310 can subscribe to as many node edges (e.g., directed edges of the directed graph architecture) as is required to make the determination of whether the fault is active.

In some implementations, a detector node can monitor the function output outside of a defined telecommunications channel of the directed graph. For example, the detector node 310-1 can receive the function output data through a stream that is independent from the main in-band data stream of the directed graph. For instance, the detector node 310-1 can be communicatively connected to the one or more function nodes 235-1/235-2 over a second channel 345 different from the first channel 245 (e.g., the first channel over which the one or more directed edges 245 between the plurality of function nodes of the directed graph 305 are defined). An out-of-band data mechanism can provide a conceptually independent channel, which can allow any data sent via that mechanism to be kept separate from in-band data. In this manner, the detector nodes 310 can be placed, throughout the directed graph 305, out-of-band of hardware components and/or the directed edges 245 of the directed graph 305 to reduce latency, maximize flexibility, and ensure secure communications.

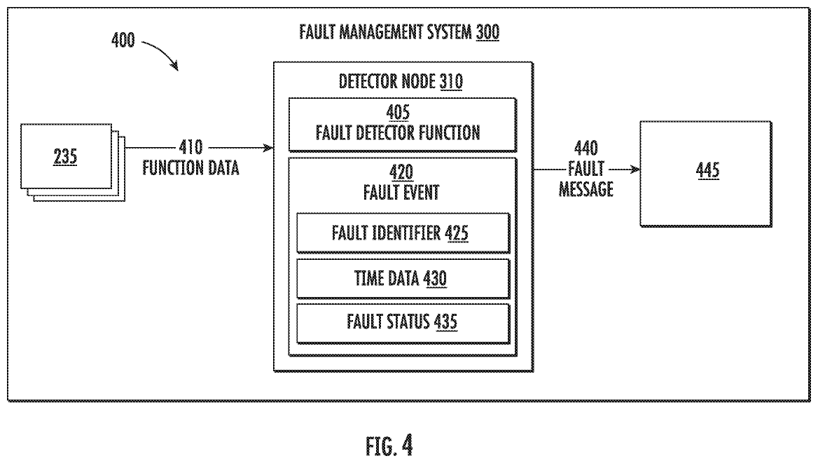

With reference to FIG. 4, FIG. 4 depicts an example fault detector data flow diagram 400 according to example implementations of the present disclosure. The detector node 310 can be configured to detect the existence of a fault associated with an autonomous vehicle based on output function data 410 received from one or more function node(s) 235. The detector node 310 can be responsible for identifying and indicating a single fault. In some implementations, the detector node 310 does not prescribe a severity of action if the fault is active, rather it is solely configured to indicate whether the fault is active and/or inactive.

The detector node 310 can be configured to perform a fault detection function 405 on the function output data 410 to identify the existence (e.g., active state) of the fault. The fault detection function 405 can include a boolean function, a range function, a high/low limit function, a sliding window function, and/or any other computing algorithm capable of detecting an off-nominal condition. A boolean function, for example, can be used either as a simple signal (e.g., “is the mushroom button pressed?”) or as the result of more complex evaluations from other functions (e.g., “is the camera image quality degraded?”). The range function can be used to detect whether a component is within its operational limits (e.g., “is the LiDAR operating within its specified temperature range?”). For range detection, a range can be statically defined within the range function and/or dynamically provided by another input and constrained to a reasonable limit.

In some implementations, the existence of a fault can be time dependent. In such a case, the detector node 310 can include and/or be associated with a periodic trigger (e.g., a heartbeat trigger) and/or a global timer (e.g., defined by directed graph architecture). The periodic trigger and/or global timer can be utilized to compare the function output 410 to a period of time. For instance, a detector node 310 can include a sliding window function that can detect whether acceptable rates are exceeded over time (e.g., “number of dropped packets in the past second exceed a threshold,” “a high percentage of recent requests have been rejected,” etc.). The sliding window function can allow a detector node 310 to perform calculations on time-series data: counts, sums, rates, etc. Each sliding window function can include a required time horizon and/or a sampling rate. By way of example, a counter diagnostic can be implemented as a sliding window sum function where the maximum allowable rate can be 0.

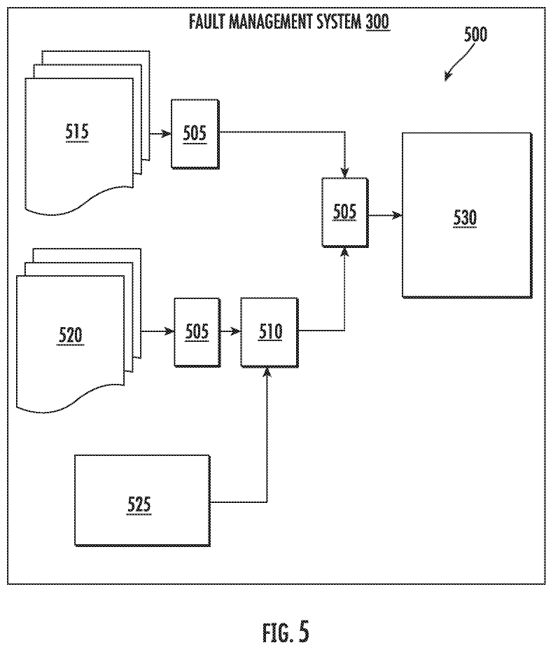

Each detector node 310 can be configured to determine a single specific fault. For instance, a high and low function can be implemented as individual checks for high and/or low data thresholds. In some implementations, a number of detector nodes can be combined to determine compound faults. By way of example, FIG. 5 depicts an example fault detector combination 500 according to example implementations of the present disclosure. The fault management system 300 can include a first detector node 515 configured to detect whether a function output exceeds a high data threshold, a second detector node 520 configured to detect whether a function output fails to reach a low data threshold, and/or a third detector node 525 configured to detect whether the function output is out of range (e.g., either exceeds the high data threshold or fails to reach the low data threshold). The first 515, second 520, and/or third detector nodes 525 can each be configured to obtain the same function output and detect an existence of a unique fault based on the function output.

In some implementations, the multiple detector nodes 515, 520, 525 can be communicatively connected to detect compound faults. A compound fault, for example, can include a fault that exists based on the existence of a plurality of sub faults. For instance, one or more sub detector nodes 515, 520, 525 can be connected to an aggregator detector 530 to check for faults only present when two or more faults (or fault conditions) are active. The faults detected by two or more different detector nodes 515, 520, 525 can be logically combined (e.g., via one or more OR gates 505, AND gates 510, etc.) to detect the compound fault. By way of example, an air cleaning system can have a compressor fault in the event that: (1) the pressure is low and (2) the compressor has been on for a period of time. The fault management system 300 can simplify the interfaces for detector nodes 515, 520, 525 by including a first detector node 515 configured to detect whether the pressure of the air cleaning system is low, and a second detector node 520 configured to detect whether the compressor has been on for a period of time. The resulting outputs of each detector can be combined (e.g., by another detector node and/or one or more gates 505, 510) to determine whether the compressor fault is active.

Turning back to FIG. 4, the detector node 310 can be configured to output a fault message 440 indicative of the fault event 420 to an associated fault handler node 445 based on the existence of the fault (e.g., an active/inactive status 435 of the fault) and a fault type of the detector node 310. A fault event 420, for example, can include fault status data. By way of example, each fault detection function 405 can return fault status data. The fault status data can include a fault event identifier 425, time data 430, and/or a fault status 435 indicative of whether the fault is active and/or inactive. The time data 430 can include a fault timestamp and/or fault data timestamp. The fault timestamp can be indicative of a time at which the fault was detected by the detector node 310. The fault data timestamp can be indicative of a time at which the function output 410 resulting in the fault was received, generated, and/or output by a respective function node 235.

The fault event identifier 425 can include a unique fault identifier associated with the detector node 310. In some implementations, each detector node 310 can include a unique fault identifier 425 to distinguish between outputs of the various detector nodes of the fault management system 300. By way of example, each respective detector node (e.g., detector node 310) can be defined by a fault type. A fault type, for example, can be indicative of the nature of the fault and/or the placement of the detector node 310 within the directed graph. As an example, a fault type can include a low air pressure compressor type indicating that the detector node 310 is configured to obtain a function output 410 from a compressor status parser function node 235 (e.g., a function node configured to analyze a compressor sensor of the autonomous vehicle) and that the air pressure from the compressor is low (e.g., as indicated by function output 410 provided by the compressor status parser function node 235). As another example, a fault type can include a compressor time type indicating that the detector node 310 is configured to obtain function output 410 from the compressor status parser function node 235 and that the compressor has been running for a period of time (e.g., as indicated by function output 410 provided by the compressor status parser function node 235). An additional example can include an air compressor fault type indicating that the detector node 310 is configured to obtain function output 410 from one or more sub detector nodes 235 and that the pressure of an air cleaning system of the autonomous vehicle is low (e.g., as indicated by the function output 410 provided by the one or more sub detector nodes 235).

Returning to FIG. 3, a fault type can indicate that a detector node 310 is connected to any function node of the plurality of function nodes 235 of the directed graph 305 (e.g., one or more LiDAR sensor parser function nodes, a trajectory function node, etc.). Moreover, each fault type can indicate a specific fault associated with an autonomous vehicle (e.g., low air pressure, loss of data, corrupted messages, etc.). In some implementations, each fault type can be associated with a fault severity. The fault severity can be indicative of a level of severity of a fault detected by a respective detector node 310.

A fault severity can correspond to a respective fault severity level of a plurality of predefined fault severity levels. By way of example, the plurality of predefined fault severity levels can include an emergency fault level, a transition fault level, an unaware stop fault level, an aware stop fault level, a designated park fault level, a maintenance fault level, among other fault severity levels indicative of a respective severity of one or more fault types. Each of the defined levels can range from most severe to least severe. For instance, an emergency fault level can be the most severe fault severity level. In addition, or alternatively, the maintenance fault level can be the least severe fault severity level.

The plurality of function nodes 235 of the directed graph 305 can include a plurality of fault handler nodes 320A-F. In some implementations, the plurality of fault handler nodes 320A-F can include a respective node for each fault severity level of the plurality of predefined fault severity levels. By way of example, the plurality of fault handler nodes 320A-F can include an emergency node 320F, a transition node 320E, an unaware stop node 320D, an aware stop node 320C, a designated park node 320B, and/or a maintenance node 320A. In this manner, a fault handler node can be associated with a respective fault severity. The fault handler nodes 320A-F can be configured to handle all faults detected by a detector node of a fault type associated with the respective fault severity.

More particularly, each respective detector node of the plurality of detector nodes 310 can be associated with a fault handler node of the plurality of fault handler nodes 320A-F. For example, each detector node 310 can be configured to output data to an associated fault handler node 320A-F (e.g., via the connected edge 245) based on the fault type of the detector node 310. For instance, each fault type of the plurality of fault types can correspond to a fault severity as indicated by a directed edge 245 of the directed graph 305. The directed edge 245, for example, can connect a detector node 310 defined by a respective fault type to a respective fault handler node 320A-F configured to handle faults of a respective severity level. By connecting the detector node defined by the respective fault type to the respective fault handler node, the directed edges 245 can indicate that the respective fault type is associated with the respective severity level corresponding to the respective fault handler node. By way of example, the detector node 310-1 connected, via a directed edge 245-1, to an emergency node 320F can be defined by a fault type associated with an emergency fault level. In this manner, the configuration of edges 245 between the plurality of detector nodes 310 and the plurality of fault handler nodes 320A-F of the fault management system 300 can determine the severity level associated with a fault type defining each of the plurality of respective detector nodes 310.

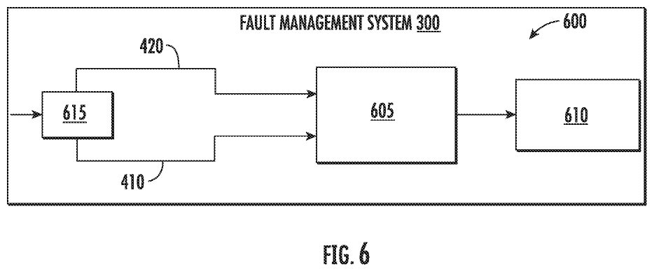

With reference to FIG. 6, FIG. 6 depicts an example fault handler data flow diagram 600 according to example implementations of the present disclosure. A fault handler node 605 can be configured to obtain a fault event 420 and function output 410 associated with the fault event 420 based on the fault type of a respective detector node 615 and initiate a fault response 610 for an autonomous vehicle based at least in part on the fault event 420 and function data 410. For instance, the fault handler node 605 can receive the function output data 410 from a function node 615 and the fault event 420 from a respective detector node 615. In some implementations, the fault event 420 can include a fault status associated with the function output data 410. The fault status and the function output data 410 can be communicated to the fault handler node 605 by the function node 615 after a fault event 420 is detected.

Turning back to FIG. 3, a fault response can include one of a plurality of fault responses. The plurality of fault responses can include one or more filtering responses and/or vehicle responses. The vehicle response(s) can include a stop in a current travel way of the autonomous vehicle, a stopping maneuver to move the autonomous vehicle out of the travel way, a transition from an autonomous state to a manual state, a parking maneuver at a designated area, a navigation to a maintenance facility, and/or any other vehicle action to safely handle a fault. A respective fault handler node of the plurality of fault handler nodes 320A-F can be associated with a respective fault response that corresponds to the fault severity associated with the respective fault handler node. By way of example, an emergency node 320F can be associated with a stop in a current travel way of the autonomous vehicle, a transition node 320E can be associated with a transition from an autonomous state to a manual state, an unaware stop node 320D can be associated with a stopping maneuver to move the autonomous vehicle out of the travel way, an aware stop node 320C can be associated with another stopping maneuver to move the autonomous vehicle out of the travel way after clearing an obstacle, an designated park node 320B can be associated with a parking maneuver at a designated area, and/or a maintenance node 320A can be associated with a navigation to a maintenance facility.

The directed graph 305 of the fault management system 300 can also include a plurality of action function nodes 330. The plurality of action function nodes 330 can be configured to cause the performance of the one or more vehicle actions. For instance, each action function node 330 can be configured to cause the performance of a respective vehicle action. As an example, an action function node 330-2 can include a trajectory generation node configured to generate a vehicle trajectory. The trajectory generation node can be configured to cause an autonomous vehicle to follow a respective trajectory by generating the respective trajectory and providing the respective trajectory to a motion planning node 330-1. As another example, an action function node can include the motion planning node 330-1 configured to generate a motion plan for the autonomous vehicle. The motion planning node 330-1 can be configured to cause an autonomous vehicle to implement a respective motion plan (e.g., to a designated parking location) by generating the respective motion plan and providing the respective motion plan to a vehicle control system. In this manner, each action function node of the plurality of action function nodes 330 can be associated with a vehicle response of the one or more vehicle responses. For instance, a respective action function node can cause the performance of a vehicle action corresponding to a vehicle response.

Each fault handler node 320A-F can be communicatively connected to at least one action function node 330. By way of example, in some implementations, each fault handler node 320A-F can be placed in-line with the directed graph 305 relative to at least one action function node 330. For instance, a respective fault handler node can be communicatively connected, over the first channel 245, to a respective action function node. The respective action function node, for example, can be configured to cause the performance of a vehicle action corresponding to a respective fault response associated with the respective fault handler node. In this manner, a respective fault handler node can initiate a vehicle response for the autonomous vehicle based on a fault event by communicating with the action function node configured to cause the performance of the vehicle response.

To do so, in some implementations, each fault handler node 320A-F can be configured to control the flow of data within the directed graph 305. By way of example, the one or more fault responses can include one or more filter responses. Each filter response can initiate, modify, and/or have no effect on a vehicle action caused by a respective action function node. A fault handler node of the plurality of fault handler nodes 320A-F can receive a plurality of messages directed to a respective action function node and perform a filter response before the message reaches the action function node. For example, the fault handler node 320A can permit the normal flow of traffic by providing one or more of the plurality of messages to the respective action function node 330-2, block one or more of the plurality of the messages from the action function node 330-2, and/or communicate a safety message to the action function node 330-2, for example, by flagging a message and forwarding the message the action function node 330-2. The safety message, for example, can initiate a respective vehicle response associated with the fault handler node 320A. In this manner, each fault handler node 320A-F can be configured to control which messages are received by a respective action function node of the directed graph 305 by initiating a filter response.

As an example, a fault handler node 320D communicatively connected to a motion planning node 330-1 can receive a plurality of messages addressed to the motion planning node 330-1 such as, for example, one or more trajectory messages from a trajectory action node 330-2. The fault handler node 320D can stop a trajectory message from reaching the motion planning node 330-1, forward the message to the motion planning node 330-1, and/or modify the message (e.g., by flipping a flag indicative of a command, modifying an input value, etc.) and forward the modified message to the motion planning node 330-1, for example, to initiate a vehicle response.

The fault handler node(s) 320A-F can initiate a fault response (e.g., filter response and/or vehicle response) based on a fault event. For instance, the fault handler node(s) 320A-F can be configured to block and/or communicate one or more messages to a respective action function node based on the fault event. For example, the fault handler node(s) 320A-F can store a fault status indicative of the existence of a fault. The fault handler node(s) 320A-F can update the fault status based on the fault event. The fault handler node(s) 320A-F can determine a fault response for one or more messages based on the fault status. For instance, the fault handler node(s) 320A-F can initiate a blocking filter response and/or initiate a vehicle response in the event the fault status is active. In addition, or alternatively, the fault handler node(s) 320A-F can initiate a permission filter response in the event that the fault status is inactive.

In some implementations, the fault handler node(s) 320A-F can receive multiple fault events (e.g., first fault event, second fault event, etc.) indicative of multiple faults (e.g., first fault, second fault, etc.) from multiple detector nodes 310 (e.g., first detector node, second detector node, etc.) associated with the fault handler node(s) 320A-F. In such a case, the fault handler node(s) 320A-F can determine a prioritization of the multiple faults (e.g., first fault, second fault, etc.) based on the multiple fault events (e.g., the first fault event, second fault event, etc.). By way of example, the first fault can be indicative of a reoccurring air compressor fault indicative of a faulty air compressor sensor. A fault handler node (e.g., 320A) can receive a fault event indicative of the first fault and prioritize other faults, such as a second fault indicative of a new faulty LiDAR sensor fault, over the first fault because the first fault is expected (e.g., reoccurring).

In addition, or alternatively, the fault handler node(s) 320A-F can initiate a fault response based on a fault event and a context of a vehicle computing system of an autonomous vehicle associated with the fault management system 300. The context of the vehicle computing system can be indicative of a state of the vehicle computing system. For instance, the context of the vehicle computing system can include a vehicle operating mode (e.g., manual, semi-autonomous, autonomous, etc.) of the vehicle computing system. A fault handler node (e.g., 320D) can obtain state data indicative of the state of the vehicle computing system and can initiate the fault response based at least in part on the state. For instance, the fault handler node 320D can compare the fault event to the state data to determine the fault response. By way of example, if the fault handler node is communicatively connected to a motion planner node 330-1 and receives a fault event indicative of a faulty trajectory, the fault handler node 320D can block the faulty trajectory from the motion planner node 330-1 in the event the vehicle computing system is in a manual driving mode and initiate a vehicle response (e.g., a safe stop) in the event the vehicle computing system is in an autonomous driving mode.

As discussed above, the fault handler nodes 320A-F can be included in-line with the directed graph 305 where the fault event is expected to affect the execution of the directed graph 305. In this manner, the fault management system 300 allows explicit connections between faults and vehicle actions. By placing the fault handler nodes 320A-F in this manner, the fault management system 300 eliminates the need to send fault responses across devices/containers/process boundaries, etc. of a vehicle computing system. Moreover, the fault handlers 320A-F can be placed based on importance (e.g., the severity level associated with the fault handler). For example, a first fault handler 320F (e.g., an emergency node) configured to handle more severe fault levels (e.g., faults associated with an emergency fault level) can be placed with respect to a vehicle control system, thereby enabling the fault handler 320F to directly cause a motion of the vehicle (e.g., an emergency stop). In addition, a second fault handler 320A (e.g., an L3 node) configured to handle less severe fault levels (e.g., faults of an L3 fault level) can be placed with respect to a trajectory generation node 330-2, thereby enabling the fault handler to directly cause the generation of a safety trajectory. In this manner, in the event that an L3 fault and a safety stop fault occur simultaneously, the directed graph 305 will generate a safety trajectory (e.g., in response to the L3 fault), but ultimately perform an emergency stop (e.g., in response to the safety stop fault).

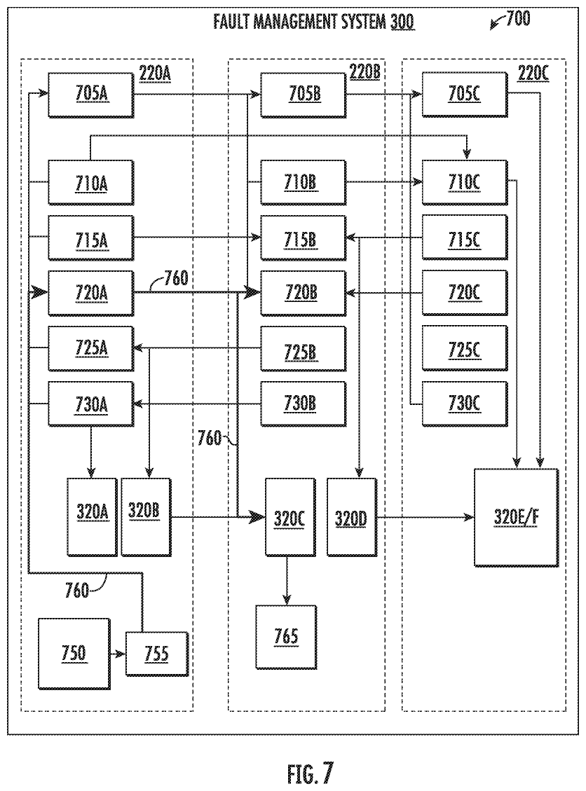

Turning to FIG. 7, FIG. 7 depicts an example fault propagation technique 700 according to example implementations of the present disclosure. As discussed herein, a vehicle computing system of an autonomous vehicle can be configured to run one or more processes 220A-C by executing a respective subset of function nodes for each respective process of the one or more processes. In some implementations, a detector node 755 can be associated with a first process 220A (e.g., connected to a function node 750 of the first function graph 220A) of the directed graph (e.g., directed graph 305 depicted in FIG. 3) and the associated fault handler node 320C can be associated with a second process 220B (e.g., connected to an action function node of a second function graph 22B) of the directed graph (e.g., directed graph 305 depicted in FIG. 3). The fault management system 300 can utilize one or more per-level filters 710A-C, 715A-C, 720A-C, 725A-C, 730A-C at the one or more processes 220A-C (e.g., the first function graph, the second function graph, etc.) to propagate fault information between the detector 755 and associated fault handler 320C. For instance, the one or more per-level filters 710A-C, 715A-C, 720A-C, 725A-C, 730A-C can act as an OR gate between a plurality of faults signals of processes 220A-C. For example, each process of the one or more processes 220A-C can include a plurality of per-level filters 710A-C, 715A-C, 720A-C, 725A-C, 730A-C. Each respective per-level filter of the plurality of per-level filters 710A-C, 715A-C, 720A-C, 725A-C, 730A-C can correspond to a fault handler node of the plurality of fault handler nodes 320A-F. For instance, each respective per-level filter of the plurality of per-level filters 710A-C, 715A-C, 720A-C, 725A-C, 730A-C can forward a respective fault event to a respective fault handler node.

Each detector node (e.g., detector node 755) for a respective process can be communicatively connected to a respective per-level filter (e.g., 720A) of the respective process (e.g., process 220A). Outputs (e.g., fault event 760) from each detector node (e.g., 755) can be wired into a filter function of a respective per-level filter (e.g., 720A). The detector node (e.g., 755) can be communicatively connected to the respective per-level filter (e.g., 720A) based, at least in part, on the fault type of the detector node (e.g., 755). For example, the detector node (e.g., 755) can be communicatively connected to a per-level filter (e.g., 720A) corresponding to a fault handler (e.g., 320C) configured to handle fault events of the fault type of the detector node (e.g., 755).

By way of example, per-level filter 720A can be configured to obtain a message 760 indicative of a fault event from a respective detector node 755, apply a filter logic to the fault event, and communicate the message 760 indicative of the fault event to a respective fault handler node 320C based at least in part on the filter logic. The filter logic, for example, can be configured to determine that the fault event includes a unique fault status different than a fault status of a previous fault event that was previously obtained by the per-level filter 720A. For instance, the per-level filter 720A can be configured to communicate the fault event to the respective fault handler node 320C in response to determining that the fault event includes the unique fault status and ignore the fault event in response to determining that the fault event does not include a unique fault status. The fault handler node 320C can communicate with a respective action node 765 based on the message 760.

In the event that a per-level filter (e.g., 725A, 730A) corresponds to a fault handler node (e.g., 320A, 320B) within the same process (e.g., 220A), the per-level filter can output the fault event directly to the fault handler node (e.g., 320A-B). In the event that the per-level filter (e.g., 720A) corresponds to a fault handler node (e.g., 320C) running in a different process (e.g., 220A and 220B), the per-level filter (e.g., 720A) can output the fault event to a local per-level filter (e.g., 720B) corresponding to the fault handler node (e.g., 320C) within the different process (e.g., 220B). In this manner, per-level filters at each process can limit redundant network traffic across processes.

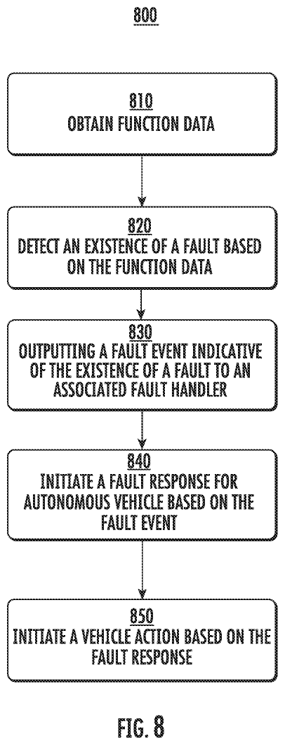

Turning to FIG. 8, FIG. 8 depicts a flowchart of a method 800 for managing faults according to aspects of the present disclosure. One or more portion(s) of the method 800 can be implemented by a computing system that includes one or more computing devices such as, for example, the computing systems described with reference to the other figures (e.g., the vehicle computing system 112, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1, 2A-2B, 9, etc.), for example, to handling faults within an autonomous vehicle computing system. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

At 810, the method 800 can include obtaining function data. For example, a computing system (e.g., vehicle computing system 112, etc.) can receive, by a first type of node of the computing system, function data from at least one function node of the computing system.

At 820, the method 800 can include detecting an existence of a fault based on the function data. For example, a computing system (e.g., vehicle computing system 112, etc.) can detect, by the first type of node of the computing system, an existence of a fault based, at least in part, on the function data.

At 830, the method 800 can include outputting a fault event indicative of the existence of a fault to an associated fault handler. For example, a computing system (e.g., vehicle computing system 112, etc.) can output, by the first type of node to a second type of node of the computing system, a fault event indicative of the existence of the fault and a fault type of the fault. For instance, the computing system can generate the fault event based on the existence of the fault. The fault event can include a fault event identifier, a fault timestamp, a fault data timestamp, and a fault status indicative of whether the fault is active or inactive.

At 840, the method 800 can include initiating a fault response for an autonomous vehicle based on the fault event. For example, a computing system (e.g., vehicle computing system 112, etc.) can initiate, by the second type of node of the computing system, at least one fault response based, at least in part, on the fault event and a context of the computing system. The context of the computing system, for example, can be indicative of a state of the computing system. By way of example, the context of the computing system can be indicative of a vehicle operating mode.

At 850, the method 800 can include initiating a vehicle action based on the fault response. For example, a computing system (e.g., vehicle computing system 112, etc.) can initiate the vehicle action based on the fault response. A third type of node of the computing system, for example, can be configured to cause the performance of a vehicle action corresponding to a fault response.

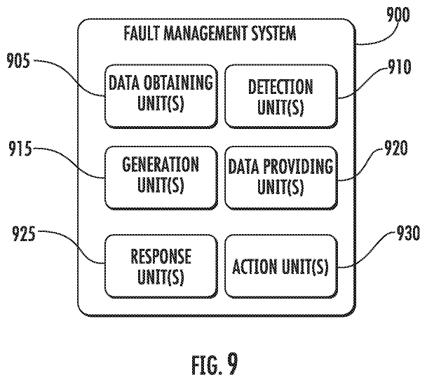

FIG. 9 depicts an example fault management system 900 with various means for performing operations and functions according example implementations of the present disclosure. One or more operations and/or functions in FIG. 9 can be implemented and/or performed by one or more devices (e.g., one or more computing devices of the vehicle computing system 112) or systems including, for example, the operations computing system 104, the vehicle 102, or the vehicle computing system 112, which are shown in FIG. 1. Further, the one or more devices and/or systems in FIG. 9 can include one or more features of one or more devices and/or systems including, for example, the operations computing system 104, the vehicle 102, or the vehicle computing system 112, which are depicted in FIG. 1.

Various means can be configured to perform the methods and processes described herein. For example, a fault management system 900 can include data obtaining unit(s) 905, detection unit(s) 910, generation unit(s) 915, data providing unit(s) 920, response unit(s) 925, action unit(s) 930, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s) 905, etc.) can be configured to obtain a function data from one or more function nodes of a plurality of function nodes arranged in a directed graph architecture. The means (e.g., detection unit(s) 910, etc.) can be configured to detect an existence of a fault associated with an autonomous vehicle based on the function data. The means (e.g., generation unit(s) 915, etc.) can be configured to generate a fault event based on the existence of the fault.

The means (e.g., data providing unit(s) 920, etc.) can output the fault event indicative of the existence of the fault and a fault type of a detector node of the plurality of function nodes that detected the fault. The means (e.g., response unit(s) 925, etc.) can initiate a fault response for the autonomous vehicle based on the fault event. The means (e.g., action unit(s) 930, etc.) can initiate a vehicle action in response to the fault response.

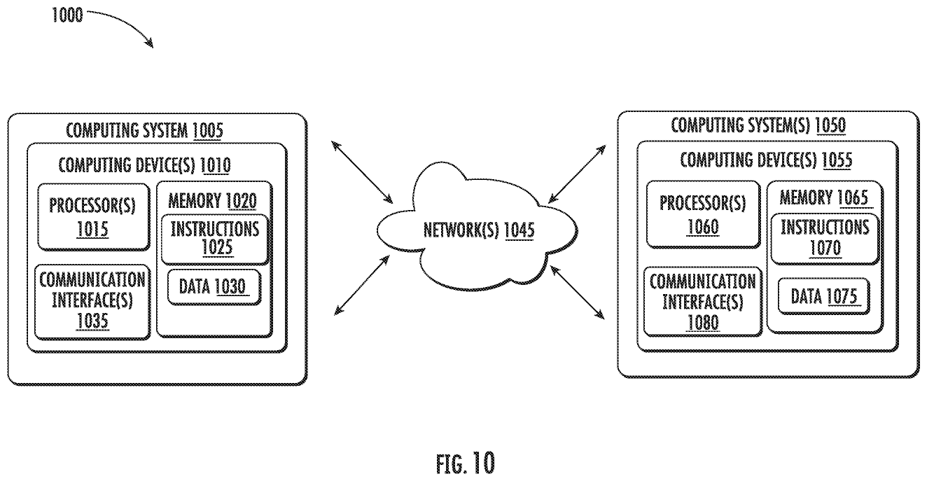

FIG. 10 depicts example system components of an example system 1000 according to example embodiments of the present disclosure. The example system 1000 can include the computing system 1005 (e.g., vehicle computing system 112, one or more vehicle devices, etc.) and the computing system 1050 (e.g., operations computing system 104, remote computing devices 106, one or more vehicle devices, etc.), etc. that are communicatively coupled over one or more network(s) 1045.

The computing system 1005 can include one or more computing device(s) 1010. The computing device(s) 1010 of the computing system 1005 can include processor(s) 1015 and a memory 1020. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 can store information that can be accessed by the one or more processors 1015. For instance, the memory 1020 (e.g., one or more non-transitory computer-readable storage mediums, memory devices) can include computer-readable instructions 1025 that can be executed by the one or more processors 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processors 1015 cause the one or more processors 1015 to perform operations such as any of the operations and functions for which the computing systems are configured, as described herein.

The memory 1020 can store data 1030 that can be obtained, received, accessed, written, manipulated, created, and/or stored. The data 1030 can include, for instance, function data, output data, input data, fault data, response data, etc. as described herein. In some implementations, the computing device(s) 1010 can obtain from and/or store data in one or more memory device(s) that are remote from the computing system 1005 such as one or more memory devices of the computing system 1050.

The computing device(s) 1010 can also include a communication interface 1035 used to communicate with one or more other system(s) (e.g., computing system 1050). The communication interface 1035 can include any circuits, components, software, etc. for communicating via one or more networks (e.g., 1045). In some implementations, the communication interface 1035 can include for example, one or more of a communications controller, receiver, transceiver, transmitter, port, conductors, software and/or hardware for communicating data/information.

The computing system 1050 can include one or more computing devices 1055. The one or more computing devices 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more non-transitory computer-readable storage media, such as RAM, ROM, EEPROM, EPROM, one or more memory devices, flash memory devices, etc., and combinations thereof.

The memory 1065 can store information that can be accessed by the one or more processors 1060. For instance, the memory 1065 (e.g., one or more non-transitory computer-readable storage mediums, memory devices) can store data 1075 that can be obtained, received, accessed, written, manipulated, created, and/or stored. The data 1075 can include, for instance, fault data, response data, and/or other data or information described herein. In some implementations, the computing system 1050 can obtain data from one or more memory device(s) that are remote from the computing system 1050.

The memory 1065 can also store computer-readable instructions 1070 that can be executed by the one or more processors 1060. The instructions 1070 can be software written in any suitable programming language or can be implemented in hardware. Additionally, or alternatively, the instructions 1070 can be executed in logically and/or virtually separate threads on processor(s) 1060. For example, the memory 1065 can store instructions 1070 that when executed by the one or more processors 1060 cause the one or more processors 1060 to perform any of the operations and/or functions described herein, including, for example, any of the operations and functions of the devices described herein, and/or other operations and functions.

The computing device(s) 1055 can also include a communication interface 1080 used to communicate with one or more other system(s). The communication interface 1080 can include any circuits, components, software, etc. for communicating via one or more networks (e.g., 1045). In some implementations, the communication interface 1080 can include for example, one or more of a communications controller, receiver, transceiver, transmitter, port, conductors, software and/or hardware for communicating data/information.

The network(s) 1045 can be any type of network or combination of networks that allows for communication between devices. In some embodiments, the network(s) 1045 can include one or more of a local area network, wide area network, the Internet, secure network, cellular network, mesh network, peer-to-peer communication link and/or some combination thereof and can include any number of wired or wireless links. Communication over the network(s) 1045 can be accomplished, for instance, via a network interface using any type of protocol, protection scheme, encoding, format, packaging, etc.

FIG. 10 illustrates one example system 1000 that can be used to implement the present disclosure. Other computing systems can be used as well. Computing tasks discussed herein as being performed at a cloud services system can instead be performed remote from the cloud services system (e.g., via aerial computing devices, robotic computing devices, facility computing devices, etc.), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A vehicle fault management system of a vehicle computing system comprising:
one or more computing devices comprising:
a plurality of function nodes arranged in a directed graph architecture, wherein the plurality of function nodes comprise:
a plurality of detector nodes, each respective detector node defined by a fault type, and
a plurality of fault handler nodes, wherein each respective detector node is associated with a fault handler node; and
one or more processors; and
one or more memories storing a set of computer readable instructions that when executed by the one or more processors cause the processors to perform operations comprising
obtaining, by a detector node, function data from one or more function nodes of the plurality of function nodes,
detecting, by the detector node, an existence of a fault associated with an autonomous vehicle based, at least in part, on the function data,
outputting, by the detector node to an associated fault handler node, a fault event indicative of the existence of the fault and the fault type of the respective detector node, and
initiating, by the associated fault handler node, a fault response for the autonomous vehicle based, at least in part, on the fault event.

2. The vehicle fault management system of claim 1, wherein each fault handler node is associated with a fault severity.

3. The vehicle fault management system of claim 2, wherein each respective fault handler node is associated with a respective fault response that corresponds to the fault severity.

4. The vehicle fault management system of claim 1, wherein the fault response comprises a stop in a current travel way of the autonomous vehicle, a stopping maneuver to move the autonomous vehicle out of the travel way, a transition from an autonomous state to a manual state, a parking maneuver at a designated area, or a navigation to a maintenance facility.

5. The vehicle fault management system of claim 1, wherein each fault type of the plurality of fault types corresponds to a fault severity as indicated by an edge of the directed graph architecture.

6. The vehicle fault management system of claim 1, wherein the detector node is associated with a first process of the directed graph architecture and the associated fault handler node is associated with a second process of the directed graph architecture.

7. The vehicle fault management system of claim 1, wherein the plurality of function nodes are communicatively connected via one or more directed edges, and wherein the operations further comprise:
obtaining, by a first function node, function input data associated with the autonomous vehicle,
generating, by the first function node, function output data based at least in part on the function input data, and
communicating, by the first function node, the function output data to one or more second function nodes.

8. The vehicle fault management system of claim 7, wherein the first function node and the one or more second function nodes are communicatively connected over a first channel, and
wherein each respective detector node of the plurality of detector nodes is communicatively connected to at least one function node over a second channel different than the first channel.

9. The vehicle fault management system of claim 1, wherein the plurality of function nodes further comprises a plurality of action function nodes, wherein the associated fault handler node is communicatively connected to at least one action function node.

10. The vehicle fault management system of claim 9, wherein the associated fault handler node is configured to block or communicate one or more messages to the at least one action function node based at least in part on the fault event.

11. An autonomous vehicle comprising:
a vehicle computing system comprising one or more computing devices, the one or more computing devices comprising a plurality of function nodes arranged in a graph architecture, wherein the plurality of function nodes comprise a plurality of detector nodes, each respective detector node associated with a fault type, and a plurality of fault handler nodes, wherein each respective detector node is associated with a fault handler node;
one or more processors; and
one or more memories storing a set of computer readable instructions that when executed by the one or more processors cause the processors to perform operations comprising:
obtaining, by a first detector node, first function data from one or more first function nodes of the plurality of function nodes,
detecting, by the first detector node, an existence of a first fault based, at least in part, on the first function data,
outputting, by the first detector node to a first fault handler node, a first fault event indicative the existence of the first fault and the first fault type of the first detector node, and
initiating, by the first fault handler node, a fault response based, at least in part, on the first fault event.

12. The autonomous vehicle of claim 11, wherein the operations further comprise:
obtaining, by a second detector node, second function data from one or more second function nodes of the plurality of function nodes,
detecting, by the second detector node, an existence of a second fault based, at least in part, on the second function data, and
outputting, by the second detector node to the first fault handler node, a second fault event indicative of the existence of the second fault and the fault type of the second detector node.

13. The autonomous vehicle of claim 12, wherein initiating, by the first fault handler node, the fault response based, at least in part, on the first fault event comprises:
determining, by the first fault handler node, a prioritization of the first fault and the second fault based at least in part on the first fault event and the second fault event.

13. The autonomous vehicle of claim 11, wherein the vehicle computing system is configured to run one or more processes by executing a respective subset of function nodes for each respective process of the one or more processes.

14. The autonomous vehicle of claim 13, wherein each process of the one or more processes comprise a plurality of per-level filters, wherein each respective per-level filter of the plurality of per-level filters corresponds to a fault handler node of the plurality of fault handler nodes.

15. The autonomous vehicle of claim 14, wherein the first detector node is communicatively connected to a per-level filter based, at least in part, on the fault type of the first detector node.

16. The autonomous vehicle of claim 15, wherein the per-level filter is configured to obtain the fault event from the respective detector node, apply a filter logic to the fault event, and communicate the fault event to the first fault handler node based at least in part on the filter logic.

17. The autonomous vehicle of claim 16, wherein the filter logic is configured to determine that the fault event comprises a unique fault status different than a fault status of a previous fault event that was previously obtained by the per-level filter, and wherein the pre-level filter is configured to communicate the fault event to the first fault handler node in response to determining that the fault event comprises the unique fault status.

18. A computer-implemented method for handling faults of a vehicle, the vehicle comprising a vehicle computing system that is onboard the vehicle, the vehicle computing system comprising a directed graph architecture comprising a plurality of nodes, the method comprising:
receiving, by a first type of node of the vehicle computing system, function data from at least one function node of the vehicle computing system;
detecting, by the first type of node of the vehicle computing system, an existence of a fault based, at least in part, on the function data;
outputting, by the first type of node to a second type of node of the vehicle computing system, a fault event indicative of the existence of the fault and a fault type of the fault; and
initiating, by the second type of node of the vehicle computing system, at least one fault response based, at least in part, on the fault event and a context of the vehicle computing system, wherein the context of the vehicle computing system is indicative of a state of the vehicle computing system.

19. A computer-implemented method of claim 17, wherein outputting the fault event indicative of the existence of the fault and the fault type of the fault comprises:
generating the fault event based on the existence of the fault, wherein the fault event comprises a fault event identifier, a fault timestamp, a fault data timestamp, and a fault status indicative of whether the fault is active or inactive.

20. A computer-implemented method of claim 18, wherein the context of the vehicle computing system is indicative of a vehicle operating mode.
